(19) United States
(12) Patent Application Publication
(10) Pub. No.: US 2026/0127842 A1
(43) Pub. Date: May 7, 2026

(54) COMPUTERIZED SYSTEMS AND METHODS FOR ELECTRONIC IMAGE ANALYSIS FOR IDENTIFYING REGIONS OF INTEREST

(71) Applicant: Singular Genomics Systems, Inc., San Diego, CA (US)

(72) Inventors: Sabrina SHORE, San Diego, CA (US); Maria Elena GALLINA, San Diego, CA (US); Gina Clotilde BENEDETTO, San Diego, CA (US); Henri A. KESTER, San Diego, CA (US)

(21) Appl. No.: 19/365,610

(22) Filed: Oct. 22, 2025

Related U.S. Application Data
(60) Provisional application No. 63/715,770, filed on Nov. 4, 2024.
(60) Provisional application No. 63/733,690, filed on Dec. 13, 2024.

(51) Int. Cl. G06V 10/25; G06V 10/94

(52) U.S. Cl. CPC G06V 10/25; G06V 10/945

(57) ABSTRACT

Disclosed herein is a computer implemented method to receive a user defined region of interest selection of a sample image that is used to extract a portion of sample for analysis by an analysis device.

### CROSS-REFERENCES TO RELATED APPLICATIONS

This application claims the benefit of U.S. Provisional Application No. 63/733,690, filed Dec. 13, 2024, and U.S. Provisional Application No. 63/715,770, filed Nov. 4, 2024, each of which are incorporated herein by reference in their entirety and for all purposes.

### BACKGROUND

Historically, biological samples are received by a diagnostic organization from the transferring clinician. The diagnostic organization assesses the sample without comment from the transferring clinician even though the transferring clinician may believe that a portion of the sample is more desirable for assessment than others. Accordingly, identification of regions of interest in a sample remains a concern. Even if the transferring clinician is able to convey region of interest information to the sequencing organization via in-person interactions or virtual interactions, there is currently no method to receive and utilize a region of interest selection from a transferring clinician to define the portion of the sample that is detected. Disclosed herein, inter alia, are solutions to these and other problems in the art.

### BRIEF SUMMARY

In an aspect provided a method of selecting a region of interest in a sample for analysis. In embodiments, the method includes providing, by a webserver, a region of interest selection session configured to allow a user to navigate a plurality of sub-sessions comprising at least a first image processing sub-session and a second data processing sub-session; capturing by a webserver a sample image during the first image processing sub-session; capturing by a webserver a region of interest boundary selection of the sample image during the first image processing sub-session; and capturing by a webserver user input during the second data processing sub-session thereby selecting a region of interest in the sample for analysis.

In another aspect is provided a method of selecting a region of interest in a sample for analysis. In embodiments, the method includes providing, by a visual display device, a region of interest selection session configured to allow a user to navigate a plurality of sub-sessions comprising at least a first image processing sub-session and a second data processing sub-session; capturing by a visual display device a sample image during the first image processing sub-session; capturing by a visual display device a region of interest boundary selection of the sample image during the first image processing sub-session; and capturing by a visual display device user input during the second data processing sub-session thereby selecting a region of interest in the sample for analysis.

In another aspect is provided a system for receiving a region of interest selection, the system including: a memory configured to store a sample image; and one or more processors in communication with the memory, the one or more processors configured to: provide a region of interest selection session configured to allow a user to navigate a plurality of sub-sessions comprising at least a first image processing sub-session and a second data processing sub-session.

In an aspect is provided a non-transitory computer-readable storage medium having stored thereon instructions that, when executed, cause one or more processors to: provide a region of interest selection session to a user, the region of interest selection session configured to allow the user to navigate a plurality of sub-sessions comprising at least a first image processing sub-session and a second data processing sub-session.

### BRIEF DESCRIPTION OF THE DRAWINGS

FIG. 1 is a block diagram illustrating an example system 100 that comprises, consists, or consists essentially of one or more example visual display device(s) 2, one or more analysis device(s) 5, network 10, one or more edge device(s) 3, and one or more webserver(s) 4, in accordance with one or more techniques disclosed herein.

FIG. 2 is a functional block diagram illustrating an example configuration of an example visual display device of FIG. 1, in accordance with one or more techniques disclosed herein.

FIG. 3 is an example user interface (UI) visualization on an example visual display device, in accordance with one or more techniques of this disclosure.

FIG. 4 is a flowchart illustrating an example method in accordance with one or more techniques of this disclosure.

FIG. 5 is a flowchart illustrating an example method in accordance with one or more techniques of this disclosure.

Like reference characters denote like elements throughout the description and figures.

### DETAILED DESCRIPTION

The aspects and embodiments described herein relate to user interfaces configured to allow a user to identify a region of interest in a tissue sample image. Aspects and embodiments of this disclosure are directed to one or more visual display devices having processing circuitry, where the processing circuitry is configured to facilitate region of interest selection for spatial sequencing. A system of processing circuitry of the one or more visual display devices may implement various tools and techniques (hereinafter, “tools,” a system of processors, or a processing circuitry system) in order to provide a virtual region of interest selection session for spatial sequencing. The processing circuitry system may be configured to provide an option for the user to engage in a region of interest selection session remotely, as in remotely from a sequencing provider's office setting or other laboratory setting or analysis device. The processing circuitry system may communicate information from the region of interest selection session over a network and/or through implementation of various communication protocols. In accordance with techniques of this disclosure, a processing circuitry system is configured to provide a comprehensive user interface (UI) to a user (e.g., the user 4), where the UI is configured to guide the user through the region of interest selection session.

### I. Definitions

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein “backend system” means the parts of a computer application or a program's code that allow it to operate and that cannot be accessed by a user.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the term “first set of data items” or “first set of data images” means data from the first sub-session which comprises, consists, or consists essentially of sample image data, image overlay, region of interest boundary, sample boundary, sample scale selection and combinations thereof.

As used herein, the term “first image processing sub-session” or “first sub-session” means a sub-session of the region of interest selection session. The first image processing sub-session may comprise additional sub-sessions for the collection of image data.

Formalin-Fixed Paraffin-Embedded (FFPE) means a form of preservation and preparation for biopsy specimens that aids in examination, experimental research, and diagnostic/drug development.

The term “genetic defect” means a mutation (a harmful change to a gene, also known as a pathogenic variant) that affect the genes or when there is the wrong amount of genetic material.

“H&E” means hematoxylin and eosin which is a common laboratory method that uses two dyes called hematoxylin and eosin that make it easier to see different parts of the cell under a microscope. Hematoxylin shows the ribosomes, chromatin (genetic material) within the nucleus, and other structures as a deep blue-purple color. Eosin shows the cytoplasm, collagen, connective tissue, and other structures that surround and support the cell as an orange-pink-red color.

As used herein, the term “image overlay” means an augmented reality overlay or overlay of the region of interest boundary, sample boundary and/or sample scale selection over the first set of data items.

As used herein, “input report” means a report that comprises, consists, or consists essentially of first set of data items and second set of data items.

The term “region of interest site” or “region of interest” or “ROI” means the portion of the sample enclosed by the region of interest boundary selection. A biological sample can have regions that show morphological feature(s) that may indicate the presence of disease or the development of a disease phenotype. For example, morphological features at a specific site within a tumor biopsy sample can indicate the aggressiveness, therapeutic resistance, metastatic potential, migration, stage, diagnosis, and/or prognosis of cancer in a subject. A change in the morphological features at a specific site within a tumor biopsy sample often correlate with a change in the level or expression of an analyte in a cell within the specific site, which can, in turn, be used to provide information regarding the aggressiveness, therapeutic resistance, metastatic potential, migration, stage, diagnosis, and/or prognosis of cancer in a subject. A region of interest in a biological sample can be used to analyze a specific area of interest within a biological sample, and thereby, focus experimentation and data gathering to a specific region of a biological sample (rather than an entire biological sample).

As used herein, the term “region of interest selection session” comprises, consists, or consists essentially of the “first image processing sub-session” and “second data processing sub-session”.

As used herein, the term “second data processing sub-session” or “second sub-session” means a sub-session of the region of interest selection session. The second image processing sub-session may comprise additional sub-sessions for the collection of sample data.

As used herein “sample” “tissue sample” or “patient sample” or the like refers to a portion of tissue that has been obtained from a living organism, fixed, sectioned, and optionally may be mounted on a planar surface, e.g., a microscope slide. The tissue sample can be a formalin-fixed paraffin-embedded (FFPE) tissue sample or a fresh tissue sample or a frozen tissue sample, etc. The tissue sample may be in the form of an FFPE block. A sample can be harvested from a subject (e.g., via surgical biopsy, whole subject sectioning, grown in vitro on a growth substrate or culture dish as a population of cells, or prepared for analysis as a tissue slice or tissue section). Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material. The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., 10-20 micrometers thick. The thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 11, 12, 13, 14, 15, 20, 30, 40, or 50 micrometers. Thicker sections can also be used if desired or convenient, e.g., at least 70, 80, 90, or 100 micrometers or more. Typically, the thickness of a tissue section is between 1-100 micrometers, 1-50 micrometers, 1-30 micrometers, 1-25 micrometers, 1-20 micrometers, 1-15 micrometers, 1-10 micrometers, 2-8 micrometers, 3-7 micrometers, or 4-6 micrometers, but as mentioned above, sections with thicknesses larger or smaller than these ranges can also be analyzed.

As used herein “sample image” or “sample image data” means an image of the sample tissue with scale for ROI selection and/or H&E image of tissue. If both an image with scale and H&E image are used, then they are of the same tissue sample.

As used herein, the term “second set of data items” means data from the second sub-session which includes user defined information or user-input data.

The term “sequence of interest” means the genetic sequence that you want to study or produce.

As used herein “spatial sequencing” means sequencing a nucleic acid molecule in an in situ environment. In embodiments, spatial sequencing may refer to viewing a specific area or a region within a tissue, then sequencing transcripts found in that region. Spatial sequencing allows the user to map variation in gene expression across a tissue or region of interest. In embodiments, spatial sequencing relies on two common molecular biology techniques, fluorescence microscopy and next-generation sequencing. As used herein, the terms “sequencing”, “sequence determination”, “determining a nucleotide sequence”, and the like include determination of a partial or complete sequence information (e.g., a sequence) of a polynucleotide being sequenced, and particularly physical processes for generating such sequence information. That is, the term includes sequence comparisons, consensus sequence determination, contig assembly, fingerprinting, and like levels of information about a target polynucleotide, as well as the express identification and ordering of nucleotides in a target polynucleotide. The term also includes the determination of the identification, ordering, and locations of one, two, or three of the four types of nucleotides within a target polynucleotide. In embodiments, sequencing includes sequencing by synthesis, sequencing by hybridization (e.g., repeatedly binding, detecting, and removing fluorescently labeled probes), sequencing by binding, sequencing by ligation, or pyrosequencing

The term “user” means any physician, technician, surgeon, or clinician. The user ordinarily, but not necessarily, is a human. In some embodiments, the user is an AI or machine learning system.

The term “user defined information” means identification information about the sample selected from one or more pre-populated drop-down menus.

The term “user-input data” means identification information about the sample inputted by the user. The sample information can include any one of or a combination of: date of sample collection, sample orientation, information about the sample origination (physical place of collection), information about the sample such as where on the patient the sample was taken from, purpose or goal of the study, detection information (detection modes and sequencing specifics), tissue information (species), tissue type (organ), FFPE blocks intended use, number of hydrogel blocks, block name, sections per block that can be used, types of controls to use etc. and/or actual region of interest on the sample.

The term “user identified region of interest selection session data” or “region of interest selection session data” means all of the information collected during a region of interest selection session which typically includes a first set of data items and a second set of data items.

As used herein, the term “UI elements” or “tiles” means one or more graphical UI visualization elements of the UI interface. The user can select tiles (e.g., via a touch input) to leverage the functionalities associated with the description of each such tile.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

All numerical designations, e.g., pH, temperature, time, concentration, and molecular weight, including ranges, are approximations which are varied (+) or (−) by increments of 0.1. It is to be understood, although not always explicitly stated that all numerical designations are preceded by the term “about”. The term “about” also includes the exact value “X” in addition to minor increments of “X” such as “X+0.1” or “X−0.1.” It also is to be understood, although not always explicitly stated, that the reagents described herein are merely exemplary and that equivalents of such are known in the art.

Unless otherwise defined, all technical and/or scientific terms used herein have the same meaning as commonly understood by one of ordinary skill in the art. Although methods and materials similar or equivalent to those described herein can be used in the practice or testing of embodiments disclosed herein, exemplary methods and/or materials are described below. In case of conflict, the patent specification, including definitions, will control. In addition, the materials, methods, and examples are illustrative only and are not intended to be necessarily limiting.

While some embodiments comprise/include the disclosed features and may therefore include additional features not specifically described, other embodiments may be essentially free of or completely free of non-disclosed elements—that is, non-disclosed elements may optionally be essentially omitted or completely omitted.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Systems and Devices

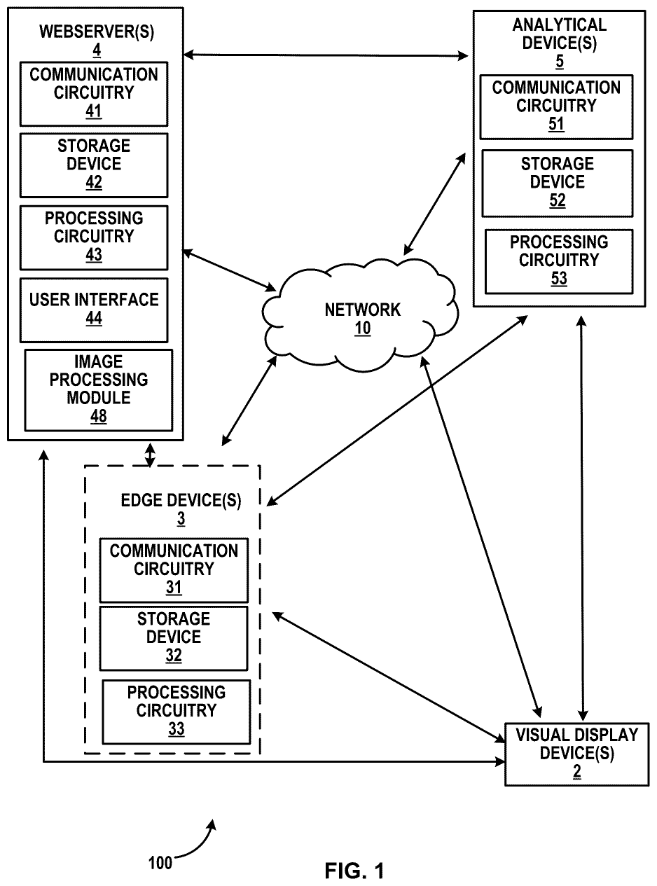

FIG. 1 illustrates the environment of an example region of interest selection system 100. System 100 comprises, consists, or consists essentially of one or more analysis device(s) 5 and one or more visual display device(s) 2. In some embodiments, analysis device(s) 5 include communication circuitry 51. In some embodiments, the analysis device(s) 5 are operationally linked to one or more of the network 10, webserver(s) 4, visual display device(s) 2, and/or edge device(s) 3. In some embodiments, the visual display device(s) 2 are operationally linked to one or more of the network 10, webserver(s) 4, analysis device(s) 5, and/or edge device(s) 3.

In embodiments, the edge device(s) 3 are operationally linked to one or more of the network 10, webserver(s) 4, analysis device(s) 5, and/or visual display device(s) 2. In some embodiments, the webserver(s) 4 are operationally linked to one or more of the network 10, analysis device(s) 5, visual display device(s) 2, and/or edge device(s) 3. In embodiments, the network 10 is operationally linked to one or more of the analysis device(s) 5, webserver(s) 4, visual display device(s) 2, and/or edge device(s) 3. In some embodiments, the edge device(s) 3 is a computing device used by the technician running the analysis device(s) 5.

In embodiments, the system is used by a user (via a UI displayed on the visual display device) to make the region of interest selection. A technician receives the region of interest selection (either on the analysis device or on a computing device (edge device 3) operationally linked to one or more of the analysis device(s) 5, network 10, webserver(s) 4, visual display device(s) 2, and/or edge device(s) 3. In some embodiments, the technician orients the analysis device to assess/sequence the sample based at least in part on the region of interest selection on the sample image. In some embodiments, an analysis device 6 receives (directly from the visual display device 2 /UI or indirectly from another feature of the system 100) the region of interest selection and the analysis device 6 automatically orients itself to assess/sequence the sample based at least in part on the region of interest selection. System 100 is implemented in any setting where at least one of visual display device(s) 2 are used for region of interest site selection, in accordance with one or more techniques disclosed herein.

In embodiments, the system communicates over a network. This network may be any type of network (including infrastructure) that provides communications, exchanges information, and/or facilitates the exchange of information, such as the Internet, a Local Area Network, or other suitable connection(s) that enables system 100 to send and receive information between the components of system 100, between the components of system 100 and other systems, and between system 100 and other systems. System 100 may be implemented as a web service, and may be implemented in accordance with representational state transfer (RESTful) principles. In various aspects, system 100 may be configured to pass data between the components of system 100 as data objects, using formats such as JSON, XML, and YAML. System 100 may be configured to expose application program interfaces (APIs) for communicating between system components. In some aspects, these APIs may be generated using an API description language such as Swagger, WSDL2.0, and/or WADL.

### Visual Display Device(s)

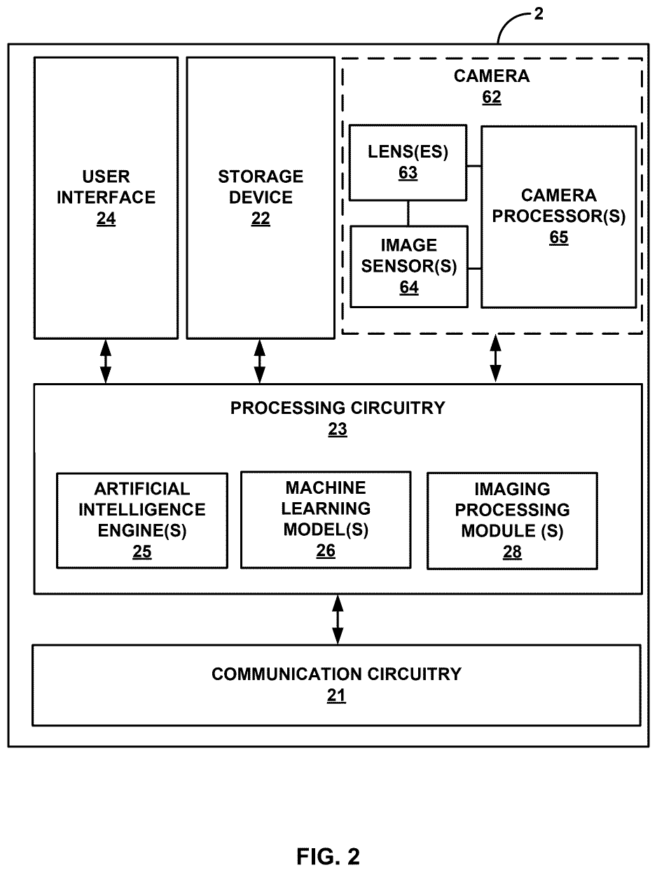

FIG. 2 is a block diagram illustrating an example configuration of components of at least one visual display device of visual display device(s) 2. In the example of FIG. 2, the at least one visual display device comprises, consists, or consists essentially of processing circuitry 23, communication circuitry 21, storage device 44, and UI 24. Visual display device(s) 2 are devices with a display viewable by a user. In some embodiments, visual display device(s) 2 may include one or more of a cellular phone, a “smartphone,” a satellite phone, a notebook computer, a tablet computer, a wearable device, a personal computer, a computer workstation, one or more servers, a personal digital assistant, a handheld visual display device, virtual reality headsets, wireless access points, motion or presence sensor devices, or any other visual display device that may run an application that enables the visual display device to interact with edge device(s) 3, the network 10, servers 4 and/or analysis device(s) 5 or interact with another computing device (edge device 3) that is, in turn, configured to interact with edge device(s) 3, the network 10, servers 4 and/or analysis device(s) 5. In some embodiments, the visual display device(s) 2 establishes a wired or wireless communication with one or more of edge device(s) 3, the network 10, servers 4 and/or analysis device(s) 5. Visual display device(s) 2, for example, may communicate via near-field communication (NFC) technologies (e.g., inductive coupling, NFC or other communication technologies operable at ranges less than 10-20 cm) and/or far-field communication technologies (e.g., Radio Frequency (RF) telemetry according to the 802.11, Bluetooth® specification sets, or other communication technologies operable at ranges greater than NFC technologies). In some embodiments, visual display device(s) 2 may include an interface for providing input to edge device(s) 3, network 10, servers 4, and/or analysis device(s) 5. For example, visual display device(s) 2 may include a user input mechanism, such as a touchscreen or keyboard or mouse, that allows a user to store sample image(s) to a database and user input date to a database either on the visual display device 2 or off of it. For example, in some embodiments, one of edge device(s) 3 may manage the database, which in some embodiments, visual display device(s) 2 may access via network 10 in order to perform one or more of the various techniques disclosed herein including but not limited to a region of interest selection session.

In embodiments, visual display device(s) 2 are configured to connect to cellular base station transceivers (e.g., for 3G, 4G, LTE, and/or 5G cellular network access), and Wi-Fi™ access points, as those connections are available. In some embodiments, the cellular base station transceivers may have connections that provide access to network 10. These various cellular and Wi-Fi™ network connections can be managed by different third-party entities, referred to herein as “carriers.”

Visual display device(s) 2 are referred to in some embodiments herein as a plurality of “visual display device(s) 2,” while in other instances are referred to simply as “visual display device 2,” where appropriate.

As discussed above, visual display device(s) 2 may interface with edge device(s) 3, network 10, webserver(s) 4, analysis device(s) 5, and/or other computing device (edge device 3) for example, by relaying the first set of data items (image of the region of interest site selection) and/or second set of data items (user input data) to the edge device(s) 3, network 10, webserver(s) 4, analysis device(s) 5, and/or other computing device (edge device 3), in accordance with one or more techniques disclosed herein. In some embodiments, edge device(s) 3, network 10, webserver(s) 4, analysis device(s) 5, and/or other computing device (edge device 3) interrogate the visual display device(s) 2 to obtain data from visual display device(s) 2, such as first set of data items and second set of data items.

### User Interface

Visual display device(s) 2 may include a user interface (UI) 23. UI 24 comprises, consists, or consists essentially of a display (not shown), such as a liquid crystal display (LCD) or a light emitting diode (LED) display or other type of screen, with which processing circuitry 23, 33, 43 or 64 may interact. In some embodiments, UI 24 may further include a command line interface. In some embodiments, visual display device(s) 2 and/or edge device(s) 3 may include a display system (not shown). In some embodiments, the display system may comprise system software for generating UI data to be presented for display and/or interaction. In some embodiments, processing circuitry, such as that of visual display device(s) 2, may receive UI data from another device, such as from one of edge device(s) 3 or webserver(s) 4, that visual display device(s) 2 may use to generate a UI for display and/or interaction.

Visual display device(s) 2 are configured to receive, via UI 24, input from the user. UI 24 may include, for example, a keyboard and a display, which may for example, be a liquid crystal display (LCD) or light emitting diode (LED) display. In some embodiments, a display of visual display device(s) 2 may include a touch screen display, and a user may interact with visual display device(s) 2 via the display. In some embodiments, the user may interact with visual display device(s) 2 via a connected device such as a mouse or keyboard. It should be noted that the user may also interact with visual display device(s) 2 remotely via a network visual display device.

The keyboard may take the form of an alphanumeric keyboard, or a reduced set of keys associated with particular functions. Visual display device(s) 2 may additionally or alternatively include a peripheral pointing device, such as a mouse, via which the user may interact with UI 24. In some embodiments, UI 24 may include a UI that utilizes virtual reality (VR), augmented reality (AR), or mixed reality (MR) UIs, such as those that are implemented via a VR, AR, or MR headset.

In embodiments, one of visual display device(s) 2, may include one or more of the system of processors implemented in circuitry, where the one or more processors are configured to provide a region of interest selection session, via visual display device 2. In some embodiments, the region of interest selection session is configured to allow a user to navigate a plurality of sub-sessions (e.g., via visual display device 2). The plurality of sub-sessions may include a first sub-session and a second sub-session as part of the region of interest selection session.

In embodiments, visual display device 2 may capture via camera 32 or receive a sample image. In some embodiments, the sample image comprises, consists, or consists essentially of the sample image, such as picture frames of the sample. That is, visual display device 2 may capture picture frames of sample via a camera (e.g., camera 32 of FIG. 2) or download an image taken from another visual display device (smart phone) and may store the picture frames to memory (storage device 44). In some embodiments, the sample image may include a picture frame of a still-image of a sample.

In embodiments, visual display device 2 may capture or receive at least one region of interest boundary selection, sample boundary selection and/or sample scale selection. In some embodiments, the region of interest boundary selection, sample boundary selection and/or sample scale selection comprises, consists, or consists essentially of the sample image, such as picture frames with an image overlay of the region of interest boundary selection, sample boundary selection and/or sample scale selection. That is, visual display device 2 may capture frames of at least one region of interest boundary selection image, sample boundary selection and/or sample scale selection via a camera (e.g., camera 32 of FIG. 2) and may store the frames to memory and the user during the region of interest selection session applies a region of interest boundary to the sample image and the region of interest boundary is also stored to memory on the visual display device or other device that is operatively connected to the visual display device. In some embodiments, the region of interest boundary selection image or sample boundary selection image may include a frame of a still-image of at least one region of interest boundary selection (picture with overlay) or sample boundary selection (picture with overlay).

In embodiments, the sample image or at least one region of interest boundary selection image, sample boundary selection image and/or sample scale selection image may include a frame of a still-image of only a portion of the sample or region of interest selection, sample boundary selection and/or sample scale selection. In some embodiments, the region of interest boundary image includes the region of interest boundary selection. In some embodiments, the sample image does not include a region of interest boundary selection. In some embodiments, the sample boundary selection image includes the sample boundary selection. In some embodiments, the sample image does not include the sample boundary selection. In some embodiments, the sample image includes the sample scale selection. In some embodiments, the sample image does not include the sample scale selection. The sample image, first set of data items and second set of data items may, alternatively be stored off the visual display device(s) 2 such as on an edge device(s) 3, network 10, webserver(s) 4, and/or analysis device(s) 5. The sample image, first set of data items and second set of data items may, alternatively be stored on both the visual display device(s) 2 and on device off the visual display device(s) 2 such as an edge device(s) 3, network 10, webserver(s) 4, and/or analysis device(s) 5.

In embodiments, the visual display device(s) 2 has a storage device 44 that may include a memory, such as a memory device of visual display device(s) 2, where the memory is configured to store a first set of data items such as a sample image (e.g., frames of sample image, images of a region of interest site, images of a region of interest boundary selection, images of a sample boundary selection, images of a sample scale selection image etc.). In addition, the storage device 44 is configured to store additional data items, such as a second set of data items such as user input data. The system of processors, which may include one or more processors, are in communication with at least one of the storage devices configured to store a first set of data items and/or a second set of data items.

In embodiments, visual display device 2 processes the sample image prior to storing the sample image. In some embodiments, visual display device 2 may deploy an AI engine and/or ML model trained to identify aspects in images to make a region of interest selection, sample boundary selection and/or sample scale selection. AI engine and/or ML model may identify metrics, such as a likelihood (e.g., a confidence value) of a sequence of interest at the region of interest site or likelihood of a sample boundary.

In embodiments, visual display device(s) 2 are configured to retrieve data from analysis device(s) 5 or other computing devices (edge device 3). The retrieved data may include post-processing reports. In some embodiments, analysis device(s) 5 or other computing devices (edge device 3) are configured to push data to visual display device(s) 2. The push data may include post-processing reports.

### Imaging Device

In embodiments, visual display device(s) 2 may include an imaging device. In an illustrative example, visual display device(s) 2 may include a camera 32 or multiple cameras 62 (e.g., digital cameras), as example imaging device(s). As shown in FIG. 2, camera 32 may refer to a collective device including one or more image sensor(s) 34, one or more lens(es) 36, and one or more camera processor(s) 38 (e.g., image signal processor). In some embodiments, processing circuitry 23 may include camera processor(s) 38.

In embodiments, Camera(s) 32 are a digital camera built into visual display device(s) 2. In some embodiments, camera(s) 32 are separate from visual display device(s) 2. In some embodiments, camera(s) 32 may communicate imaging data to visual display device(s) 2 and/or other connected device (e.g., edge device(s) 2). In some embodiments, visual display device(s) 2 may include a charge-coupled device (CCD) chip. The CCD chip is configured to operate in a spectral response analysis mode using flash as an excitation (e.g., white light) light source. In some embodiments, visual display device(s) 2 may employ a CCD chip in order to analyze an image of a region of interest site. In some embodiments, visual display device(s) 2 may employ a CCD chip to provide separate color filtering analysis in different light wavelength to better detect the region of interest or sample boundary. Or to aid the user in defining the sample scale. That is, visual display device(s) 2 (or other interfaced device such as the edge device(s) 3, network 10, webserver(s) 4, analysis device(s) 5 and/or other computing device not shown) may perform a color filtering on the sample images in order to identify a region of interest or sample boundary from one or more image(s) or to help the user define the sample scale.

In some embodiments, visual display device(s) 2 may use camera 32 to image a region of interest site of the sample. In some embodiments, a storage device 44 of visual display device 2 may store sample image (e.g., still-images, etc.). In such instances, processing circuitry, such as processing circuitry 23 of visual display device 2 and/or processing circuitry 33 of edge device(s) 3, and/or processing circuitry 43 of servers 4, and/or processing circuitry 53 of analysis device(s) 5 are in communication with storage device 44.

In some embodiments, multiple cameras 62 are included with a single one of visual display device(s) 2 (e.g., a mobile phone having one or more front facing cameras and one or more rear facing cameras). In some embodiments, visual display device(s) 2 may include a first camera 32 having one or more image sensors 34 and one or more lenses 36, and a second camera 32 having one or more image sensors 34 and one or more lenses 36, etc. It should be noted that while some example techniques herein are discussed in reference to frames received from a single camera (e.g., from a single image sensor), the techniques of this disclosure are not so limited, and a person of skill in the art will appreciate that the techniques of this disclosure are implemented for any type of camera 32 and combination of cameras 62, such as a combination of cameras 62 that are included with visual display device(s) 2 or otherwise, communicatively coupled to visual display device(s) 2. In some embodiments, image sensor(s) 34 represent one or more image sensors 34 that may include image-sensor processing circuitry. In some embodiments, image sensor(s) 34 include an array of pixel sensors (e.g., pixels) for capturing representations of light.

While shown as being optionally included with visual display device(s) 2 (e.g., via dashed lines), the techniques of this disclosure are not so limited, and in some embodiments, camera 32 are separate from visual display device(s) 2, such as a stand-alone camera device or separate camera system. In any case, camera 32 are configured to capture an image of a region of interest site and transfer the sample image to processing circuitry 23 via camera processor(s) 38. In some embodiments, camera 32 are configured to achieve various zoom levels. In some embodiments, camera 32 are configured to perform cropping and/or scaling techniques to achieve a particular zoom level. In some embodiments, camera 32 are configured to manipulate an output from image sensor(s) 34 and/or manipulate lens(es) 36 in order to achieve the particular zoom level.

### Communication Circuitry

Communication circuitry 21, communication circuitry 31, communication circuitry 41, communication circuitry 51, communication circuitry 11 on network 10 (not shown), may include any suitable hardware, firmware, software or any combination thereof for communicating with another device, such as visual display device(s) 2, edge device(s) 3, network 10, webserver(s) 4, analysis device(s) 5 and/or other computing device not shown.

Under the control of processing circuitry 23, communication circuitry 21 may receive downlink telemetry from, as well as send uplink telemetry to, edge device(s) 3, network 10, webserver(s) 4, analysis device(s) 5 and/or other computing device. Communication circuitry 11, 21, 31, 41, and 51 are configured to transmit or receive signals via inductive coupling, electromagnetic coupling, NFC, RF communication, Bluetooth®, Wi-Fi™, or other proprietary or non-proprietary wireless communication schemes. In some embodiments, visual display device(s) 2 may perform telemetry selection through a sweep (e.g., TelC, TelB, TelM, Bluetooth®, etc.).

### Storage Device

Storage device 24 is configured to store information within visual display device(s) 2 during operation. Storage device 32 is configured to store information within edge device(s) 3 during operation. Storage device 96 is configured to store information within Server(s) 4 during operation. Storage device 47 (not shown) is configured to store information within analysis device(s) 5 during operation.

Storage device 44, storage device 32, storage device 42, and/or storage device 32, may include a computer-readable storage medium or computer-readable storage device. In some embodiments, storage device 44, storage device 32, storage device 42, and/or storage device 32, comprises, consists, or consists essentially of one or more of a short-term memory or a long-term memory. Storage device 44, storage device 32, storage device 42, and/or storage device 32 may include, for example, read-only memory (ROM), random access memory (RAM), non-volatile RAM (NVRAM), Dynamic RAM (DRAM), Static RAM (SRAM), magnetic discs, optical discs, flash memory, forms of electrically-erasable programmable ROM (EEPROM) or erasable programmable ROM (EPROM), or any other digital media.

In some embodiments, storage device 44, storage device 32, storage device 42, and/or storage device 32 is used to store data indicative of instructions for execution by processing circuitry associated with the storage device. In addition, in some embodiments, storage device 44, storage device 32, storage device 42, and/or storage device 32 store a sample image and/or region of interest selection boundary site selection and/or sample boundary site selection and/or sample scale selection and/or first set of data items and/or second set of data items. In some embodiments, storage device 44, storage device 32, storage device 42, and/or storage device 32 store picture frames of sample image(s), frames of region of interest selection boundary site selection and/or frames of sample boundary site selection and/or frames of sample scale selection. That is, storage device 44, storage device 32, storage device 42, and/or storage device 32 may store one or more images. Storage device 44, 32, 42 and 52 are used by software or applications running on their respective devices, visual display device(s) 2, edge device(s) 3, webserver(s) 4 and/or analysis devices 6, to temporarily store information during program execution.

In embodiments, storage device 44, storage device 32, storage device 42, and/or storage device 32 store historical region of interest selection data, historical sample boundary data, historical analysis device data, historical user data, timing information (e.g., number of days since sample collection, etc.), AI and/or ML training sets, sample image, region of interest selection boundary site selection image or sample boundary site selection image and combinations thereof.

### Website-User Interface

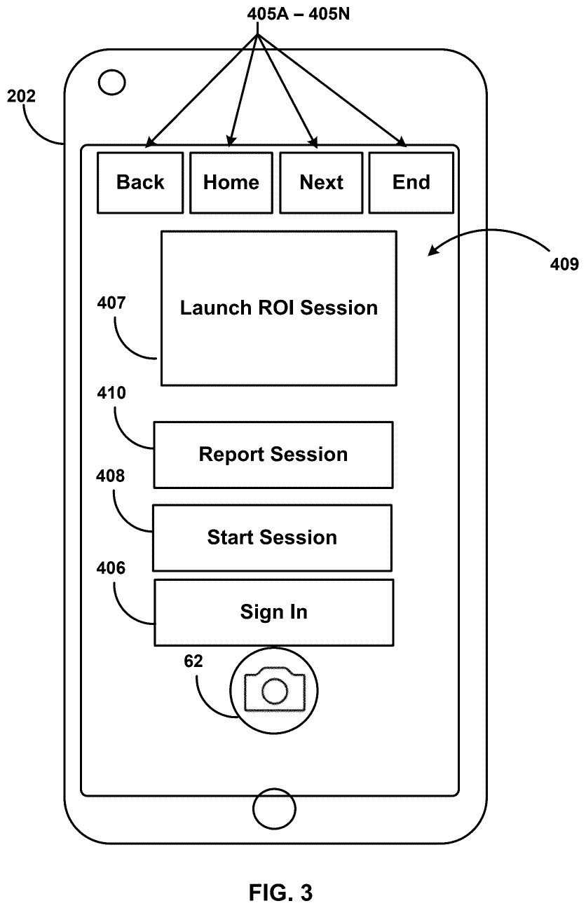

A user, may interact with UI 44 (See FIG. 3) through one or more of visual display device(s) 2. A user, may interact with UI 44 through one or more of the visual display device(s) 2, webserver(s) 4, edge device(s) 3, or the network 10 (and the processing circuitry 23 64, 43, and 53, associated therewith). In some embodiments, UI 44 is a graphical UI (GUI), an interactive UI, etc.

UI 24 may include an input mechanism to receive input from the user. The input mechanisms may include, for example, any one or more of buttons, a keyboard (e.g., an alphanumeric keyboard), a peripheral pointing device, a touch screen, or another input mechanism that allows the user to navigate through UI 44 presented by processing circuitry 23 of visual display device(s) 2 and provide input. In some embodiments, the UI 44 is located in the cloud, a website or mobile application. In such situations, the user accesses the UI 44 which is located off the visual display device(s) 2 via the visual display device(s) 2 (and the processing circuitry 23 associated therewith). In embodiments, the input is loaded as a text string into memory, for instance as a HyperText Markup Language (HTML) file. In other implementations, data on the UI may be parsed into an object tree and rendered as a web page. For instance, the resource may be parsed into an object tree, such as a document object model (DOM) tree. The DOM tree may be a hierarchical model of a particular resource. The DOM tree may include image information (e.g., image URLs, display positions, display sizes, alt text, etc.), font information (e.g., font names, sizes, effects, etc.), color information (e.g., RGB color values, hexadecimal color codes, etc.) and text information for the resource.

In embodiments, UI 44 may allow a user to rotate images and adjust zoom levels. In some embodiments, this is achieved using a touch screen of visual display device 2 (e.g., pinch-to-zoom, gestures, gaze tracking, etc.). In addition, UI 44 may allow the user to control camera parameters, such as to select a forward or rear facing camera, lighting, zoom levels, focus levels, contrast, etc., such that the user may capture images according to the camera parameters. In some embodiments, user interface 44 via processing circuitry 43 may automatically adjust such parameters, with or without initial input from the user.

The UI may include visualization tools are configured to provide a user input system and user interface, such as a desktop application that provides interactive visualization functionality to perform landmark selection, image registration, fiducial registration, image segmentation and/or any other workflows or processes described herein. In some embodiments, the visualization tools include a browser that can be configured to enable users to evaluate and interact with different views of the first image and/or the second image. In embodiments, the UI includes a display comprising image setting functionality for adjusting or configuring settings associated with image display, fiducial display, scale display, rotation, image segmentation, and/or resetting the image data. In some embodiments, the display includes one or more image manipulation tools, such as a pointer to select images, landmarks, or menu items, a lasso to select data, and a pen to annotate or mark data. In some embodiments, the display includes one or more viewing panels for viewing the first image, the second image, and/or any associated data. For example, in addition to a primary viewing panel, the display can include a secondary viewing panel that allows a user to interact with the opacity and magnification settings of the first image and/or the second image. In some embodiments, the one or more viewing panels can each individually be configured with image manipulation tools including, but not limited to, image resize functionality, image cropping functionality, image zoom functionality, image capture functionality, tile view functionality, list view functionality, or the like. For example, the selection of landmarks includes modifying the first and/or the second image. For example, in some implementations, the manual user selection of the one or more landmarks is performed by manually selecting (e.g., clicking, circling, and/or dragging and dropping a marker) the corresponding positions in the first and second images of the biological sample, as displayed on the display.

FIG. 3 shows a sample UI 44 interface on a visual display device 2 which is a mobile app or website accessed in the cloud. In some embodiments, the user navigates to a website or mobile application. To access the website, a user may input, a string of characters representing a URL or other reference identifier in order to access the website. In some embodiments, once on the website or mobile app a user may use navigation buttons (e.g., back, next, scroll buttons, etc. 405A-405N) to navigate laterally (e.g., forward, backward, etc.) through various UI 44 pages or screens.

In embodiments, the UI 44 interface may present an interface 408 on visual display device 2 (e.g., via UI 44) that comprises, consists, or consists essentially of various sign-in options. In some embodiments, interface 408 may include a sign in tile 406 or other sign in elements. UI interface may receive user input via the visual display device 2, as the user inputs data related to the sign in tile 406, in order to invoke and/or initiate a log-in session.

In embodiments, the sign-in tile prompts the user to enter a username and password, biometric data (e.g., facial data, fingerprint data, iris data, voice data, etc.)., or scan a barcode (e.g., a one-dimensional barcode, a two-dimensional barcode, Quick Response (QR) Code™, matrix barcode, etc.). The barcode can be given to the user in a kit for sample collection. Scanning the barcode may pre-populate some aspect of user input data such as date, reference number, sample collection material etc. The UI 44 interface and processing circuitry 43 may use such indications to identify and/or authenticate the particular user. Once authenticated, the UI 44 interface may load the region of interest selection session and display it on the visual display device 2. In some embodiments, a user may select a “remember this device,” “remember me,” and/or “I am the only relevant user for this device.” The UI 44 interface may receive the user input and forego a sign-in interface for future sign-in events. In embodiments, applications can perform some of the work related to authentication. For example, an application can fetch an authentication token from a client and submit an authentication request for the token (e.g., to check the validity of the authentication token) to a platform authentication service. If no authentication token is pre-sent, the application can so indicate to the platform authentication service, which can result in sign on or provisioning. An authentication token can take a variety of forms. In practice, a token is a value that can be generated, stored, communicated, and validated. As described herein, such tokens can be generated, managed, and stored as token records accessible by the primary authentication platform instance. Encryption and other techniques can be used for security purposes. Token generation can be delegated to another authority as desired. Additional information can be included in the authentication token. For example, an indication of the primary (e.g., originating, issuing, etc.) authentication platform instance can be included with the authentication token. The process of determining which instance is the primary instance can thus be accomplished by inspecting the authentication token. During the token-generation process, requests are directed to the primary instance based on tenant-specific configuration information, and the primary instance adds an indication of itself into the authentication token. Subsequent requests can thus re-use such configuration information, whether it is confirmed in the configuration information itself or not. The authentication token may include a bearer token. Such a bearer token can be validated with a secret key generated and maintained by the primary authentication platform instance. Different secret keys can be used for different tenants and different platform instances. User bearer and application bearer tokens can be implemented. The authentication token can be generated by including various information into plaintext (e.g., a pseudorandom value, the tenant identifier with which the token is associated, access control, such as which applications are permitted, and the like). Such plaintext can then be encrypted with the primary authentication platform instance secret key to generate the authentication token. Because the authentication token is validated against a central record of tokens, the central record can be updated to indicate invalidity. For example, when a user logs off, the authentication token for the session can be invalidated. Similarly, a time out can be set so that a token automatically becomes invalid after a certain period of inactivity.

In embodiments, the UI 44 interface comprises a launch ROI session. In some embodiments, the launch session interface may include a launch session tile 407.

In embodiments, UI 44 interface may launch the region of interest selection session (e.g., a virtual sign-in) when prompted by user 4, when scheduled on a specific date post sample collection, and/or in response to a push request from the technician processing the sample. In some embodiments, UI 44 interface may cause a region of interest selection session to expire after a given time. In some embodiments, the region of interest selection session may not include an explicit expiration date (e.g., a so-called “evergreen” application).

In some embodiments, the relevant data (e.g. first set of data items and second first set of data items) is stored at a time advantageous to the system so as to conserve computing resources (e.g., processing, memory, power resources, etc.). In some embodiments, the multi-faceted information representing, e.g., tiles are simultaneously or dynamically obtained from disparate systems, identified by metadata, and/or simultaneously or dynamically presented in a region of interest selection session, region of interest selection session sub-session and/or combinations thereof.

The display of information via a UI 44 where the relevant data does not necessarily reside on a storage device locally would be virtually impossible to replicate outside the realm of computer-related technology. That is, in some embodiments, relevant data (e.g., UI 44 interface, tiles, sample images, region of interest selection boundary images, sample boundary images, sample scale images, and/or user input data etc.) are stored on a cloud storage device or webserver storage device 42. In some embodiments, the relevant data are stored locally (e.g., on a visual display device 2 or mobile device of a user) and/or synchronized with a network 10 storage 12 (not shown), webserver(s) 4 storage 42, visual display device(s) 2 storage 24, analysis device(s) 5 storage 52, and/or edge device(s) 3 storage 32.

Additionally, it has been noted that design of computer UIs “that are useable and easily learned by humans is a non-trivial problem for software developers.” (Dillon, A. (2003) User Interface Design. MacMillan Encyclopedia of Cognitive Science, Vol. 4, London: MacMillan, 453-458.). The various examples of interactive and dynamic UIs of the present disclosure are the result of significant research, development, improvement, iteration, and testing and, in some embodiments, provide a particular manner of obtaining information, summarizing, and presenting information in electronic devices. This non-trivial development has resulted in the UIs described herein, which are likely to provide significant cognitive and ergonomic efficiencies and advantages over previous systems. The interactive and dynamic UIs include improved human-computer interactions that may provide, for a user, reduced mental workloads/burdens, improved decision-making, reduced work stress, etc. For example, a UI with the interactive UIs described herein may provide an optimized presentation of user-region of interest boundary selection information, sample boundary selection information, sample scale selection information and/or user input data and may enable a user/technician to more quickly access, navigate, assess, and utilize such information than with previous systems which can be slow, complex and/or difficult to learn, particularly to novice users. Thus, the presentation of concise and compact information on a particular UI that corresponds to a particular collection of data as described herein for efficient use of and optimal use of the information by an analysis device.

In some embodiments, webserver(s) 4 are managed or controlled by one or more separate entities (e.g., internet service providers (ISPs), etc.).

### Analysis Devices

In some embodiments, analysis device(s) 5 may include analysis devices such as diagnostic devices, sequencing devices (e.g., G4) and spatial sequencing devices (e.g., G4X™). The G4X is an in situ sequencing platform provided by Singular Genomics Systems, Inc. The G4X Spatial Sequencer, developed by Singular Genomics, is a high-throughput in situ sequencing platform designed for integrated multiomic analysis of cells and tissues (e.g., formalin-fixed, paraffin-embedded (FFPE) tissue samples) at subcellular resolution. The G4X enables simultaneous profiling of RNA transcripts, proteins, and fluorescent H&E staining within the same tissue section, providing comprehensive spatial context for molecular data. The G4X Spatial Sequencer utilizes fluorescence detection in its imaging processes. For example, it employs fluorescent labeling to visualize tissue morphology through fluorescent H&E staining, transcripts, and proteins simultaneously. In any case, analysis device(s) 5 are configured to communicate biological and/or medical data to UI 44 and/or visual display device(s) 2, such as via a telemetry protocol, Radio-Frequency Identification (RFID) transmission, etc. As such, any analysis device and/or visual display device are configured to communicate biological and/or medical data.

The analysis device is configured to detect analytes. As used herein, the term “analyte” refers to any biological substance, structure, moiety, or component to be analyzed. In some embodiments, the apparatus, systems, methods, and compositions described in this disclosure can be used to detect and analyze a wide variety of different analytes. Analytes can be broadly classified into two groups: nucleic acid analytes and non-nucleic acid analytes. Examples of non-nucleic acid analytes include, but are not limited to, lipids, carbohydrates, peptides, proteins, and their modified variants (e.g., glycoproteins, e.g., N-linked or O-linked, lipoproteins, phosphoproteins, specific phosphorylated or acetylated proteins, amidation, hydroxylation, methylation, ubiquitylation, and sulfation variants). Additional examples include viral proteins (e.g., capsid, envelope, coat, accessory proteins, glycoproteins, spikes), extracellular and intracellular proteins, antibodies, and antigen-binding fragments. In some embodiments, the analyte may be an organelle (e.g., nuclei or mitochondria) or localized to subcellular compartments such as organelles (e.g., mitochondria, Golgi apparatus, endoplasmic reticulum, chloroplasts, endocytic vesicles, exocytic vesicles, vacuoles, lysosomes). Analytes may also include specific peptides or proteins, including, without limitation, antibodies and enzymes. In some embodiments, analytes are detected indirectly, such as through the detection of an intermediate agent, for example, a connected probe (e.g., a ligation product) or an analyte capture agent (e.g., an oligonucleotide-conjugated antibody). These intermediate agents can bind to nucleic acid, protein, or peptide analytes within a sample.

Cell surface elements corresponding to analytes include, but are not limited to, receptors, antigens, surface proteins, transmembrane proteins, clusters of differentiation (CD) proteins, protein channels, protein pumps, carrier proteins, phospholipids, glycoproteins, glycolipids, cell-cell interaction protein complexes, antigen-presenting complexes, major histocompatibility complexes (MHCs), engineered T-cell receptors, T-cell receptors, B-cell receptors, chimeric antigen receptors (CARs), extracellular matrix proteins, and posttranslationally modified states of cell surface proteins (e.g., phosphorylation, glycosylation, ubiquitination, nitrosylation, methylation, acetylation, or lipidation). Additional examples include gap junctions and adherens junctions. Analytes can be derived from specific cell types or sub-cellular regions. For example, analytes may originate from the cytosol, cell nuclei, mitochondria, microsomes, or other cellular compartments, organelles, or portions. Permeabilizing agents targeting specific compartments or organelles can be employed to selectively release analytes for analysis. Examples of nucleic acid analytes include DNA types such as genomic DNA, methylated DNA, specific methylated DNA sequences, fragmented DNA, mitochondrial DNA, in situ synthesized PCR products, and RNA/DNA hybrids. In embodiments, sequencing is performed in-situ. In-situ sequencing methods are particularly useful, for example, when the biological sample remains intact after analytes on the sample surface (e.g., cell surface analytes) or within the sample (e.g., intracellular analytes) have been barcoded or tagged with identifying sequences. In-situ sequencing typically involves incorporation of a labeled nucleotide (e.g., fluorescently labeled mononucleotides or dinucleotides) in a sequential, template-dependent manner or hybridization of a labeled primer to a nucleic acid template such that the identities (e.g., nucleotide sequence) of the incorporated nucleotides or labeled primer extension products can be determined, and consequently, the nucleotide sequence of the corresponding template nucleic acid. Sequential fluorescence hybridization can involve sequential hybridization of probes including degenerate primer sequences and a detectable label.

In embodiments, the device and methods can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000 or more analytes present in a region of interest.

Analysis device(s) 6 are configured to transmit data, such as sensed, measured, and/or identified values of data to network 10, server(s) 94, visual display device(s) 2, and/or edge device(s) 3. In some embodiments, analysis device(s) 5 are configured to identify multiple data parameters. In some embodiments, analysis device(s) 5 are configured to identify sequence data. Edge device(s) 3 may then communicate, via communication circuitry 31 and/or network 10, the data to webserver(s) 4.

In some embodiments, analysis device(s) 5 may transmit data over a wired or wireless connection to webserver(s) 4, network 10, edge device(s) 3, or visual display device(s) 2. For example, webserver(s) 4 may receive data from analysis device(s) 5 or from edge device(s) 3. In some embodiments, edge device(s) 3 may receive, via network 10, data from webserver(s) 4. In some embodiments, edge device(s) 3 may receive, via network 10, data from analysis device(s) 5. In some embodiments, edge device(s) 3 may identify the data received from webserver(s) 4, network 10, analysis device(s) 5, or visual display device(s) 2. In some embodiments, edge device(s) 3 may store the data to a storage device 32 internal to edge device(s) 3. Processing circuitry 33 of edge device(s) 3 may also include AI engines and/or ML models, such as the AI engines and ML models. Processing circuitry 43 of webserver(s) 4 may also include AI engines and/or ML models, such as the AI engines and ML models.

In this example, analysis device(s) 5 may use communication circuitry 51 to communicate with one of edge device(s) 3 via a first wireless connection. In some embodiments, analysis device(s) 5 may use communication circuitry 51 to communicate with an access point via a second wireless connection. The access point may include a device that connects to network 10 via any of a variety of connections, such as telephone dial-up, digital subscriber line (DSL), or cable modem connections. In some embodiments, an access point is coupled to network 10 through different forms of connections, including wired or wireless connections. In some embodiments, one of visual display device(s) 2 may serve as an access point for network 10. For example, a user device, such as a tablet or smartphone, are co-located with user 4 and are configured to serve as an access point. In any case, visual display device(s) 2, edge device(s) 3, and webserver(s) 4 and/or analysis device(s) 6 are interconnected and may communicate with each other through network 10.

Analysis device(s) 6, webserver(s) 4, edge device(s) 3, and/or visual display device(s) 2 are configured to communicate, via various connections, over network 10 with remote computing resources (e.g., server(s)[not shown]). The data network (e.g., network 10) are implemented by server(s) (e.g., data servers, remote servers, analytic servers, etc.). In some embodiments, webserver(s) 4 may include a data server configured to store data and/or perform computations based on the data. In some embodiments, webserver(s) 4 may include a data server configured to store data (e.g., a database 42) and send data to another server(s) for data analytics, image processing, or other data computations, in accordance with one or more of the various techniques of this disclosure. In some embodiments, webserver(s) 4 and servers are implemented on one or more host devices, such as blade servers, midrange visual display devices, mainframe computers, desktop computers, or any other visual display device configured to provide computing services and resources. Protocols and components for communicating via the Internet or any of the other aforementioned types of communication networks are known to those skilled in the art of computer communications and thus, need not be described in more detail herein.

In embodiments, webserver(s) 4 may communicate with each of network 10, visual display device(s) 2, analysis device(s) 6, and/or edge device(s) 3, via a wired or wireless connection, to receive sequence data from analysis device(s) 5. In some embodiments, sequence data is transferred from analysis device(s) 5 to webserver(s) 4 and/or to edge device(s) 3. Server(s) 4 and/or edge device(s) 3 may perform analysis on the data to identify the presence of a sequence at a region of interest site. Server(s) 4 and/or edge device(s) 3 may transmit, via communication circuitry, a result of the analysis to visual display device(s) 2 for display and/or further processing.

In embodiments, webserver(s) 4 are configured to provide a secure storage site for data that has been collected from analysis device(s) 5, visual display device(s) 2, and/or edge device(s) 30. In some embodiments, webserver(s) 4 comprise a cloud server or other remote server that stores data collected from analysis device(s) 5, edge device(s) 3, and/or visual display device(s) 2. In some cases, webserver(s) 4 may assemble data in web pages or other virtual locations for viewing by trained professionals, such as users, clinicians, or technicians, via visual display device(s) 2. In the example illustrated by FIG. 1, webserver(s) 4 comprises, consists, or consists essentially of communication circuitry 41, a storage device 42 (e.g., to store data retrieved from analysis device(s) 5, visual display device(s) 2, and/or edge device(s) 30) and processing circuitry 43.

### Edge Devices

In some embodiments, system 100 is implemented in a setting that includes edge device(s) 3. That is, in embodiments, system 100 may operate in the context of network 10 one or more edge device(s) 3. In some embodiments, network 10 may include edge device(s) 3. Similarly, visual display device(s) 2 may include functionality of edge device(s) 3 and thus, may also serve as one of edge device(s) 3. Webserver(s) 4 may include functionality of edge device(s) 3 and thus, may also serve as one of edge device(s) 3. Similarly, analysis device(s) 5 may include functionality of edge device(s) 3 and thus, may also serve as one of edge device(s) 3.

In some embodiments, edge device(s) 3 include modems, routers, Internet of Things (IoT) devices or systems, smart speakers, screen-enhanced smart speakers, personal assistant devices, etc. In addition, edge device(s) 3 may include user-facing or client devices, such as smartphones, tablet computers, personal digital assistants (PDAs), and other mobile visual display devices.

In examples involving network 10 and/or edge device(s) 3, system 100 are implemented in a hospital setting, laboratory setting, academic setting, research setting, office setting, clinic setting or in any setting comprising network 10 and/or edge device(s) 3. The example techniques are used with analysis device(s) 5, which are in wireless communication with one or more edge device(s) 3 and other devices not pictured in FIG. 1.

In some embodiments, visual display device(s) 2 are configured to communicate with one or more webserver(s) 4, analysis device(s) 5, edge device(s) 3, or network 10 operating a network service. In some embodiments, analysis device(s) 5 may communicate, via Bluetooth®, with visual display device(s) 2.

### Network

Network 10 can include any appropriate network, including a private network, a personal area network, an intranet, a local area network (LAN), a wide area network, a cable network, a satellite network, a cellular network, a peer-to-peer network, a global network (e.g., the Internet), a cloud network, an edge network, a network of Bluetooth® devices, etc., or a combination thereof, some or all of which may or may not have access to and/or from the Internet. That is, in some embodiments, network 10 comprises, consists, or consists essentially of the Internet. In an illustrative example, visual display device(s) 2 may periodically transmit and/or receive various data items, via network 10, to and/or from one of analysis device(s) 5, and/or edge device(s) 3 and/or webserver(s) 4.

### Databases

In some embodiments, system 100 may include one or more databases (e.g., storage device 22, 32, 42 and 52) that store various medical data records, cohort data, sample images, first set of data items, second set of data items and combinations thereof.

### Processing Circuitry

Processing circuitry 23, 33, 43 and/or 53 may include one or more processors that are configured to implement functionality and/or process instructions for execution within their associated/respective devices: visual display device(s) 2, edge device(s) 3, server(s) 4, and/or analysis device(s) 5. Processing circuitry 23, 33, 43 and/or 53 are capable of processing instructions stored in their respective storage device 22, 32, 42 and/or 52. Processing circuitry 23, 33, 43 and/or 53 may include, for example, microprocessors, a digital signal processors (DSPs), an application specific integrated circuits (ASICs), field-programmable gate arrays (FPGAs), complex programmable logic devices (CPLDs), or equivalent integrated or discrete logic circuitry, or a combination of any of the foregoing devices or circuitry. Accordingly, processing circuitry 23, 33, 43 and/or 53 may include any suitable structure, whether in hardware, software, firmware, or any combination thereof, to perform the functions ascribed herein to processing circuitry 23, 33, 43 and/or 53. The instructions may include code from any suitable computer programming language such as, but not limited to, C, C++, C #, Java®, JavaScript®, Perl®, HTML, XML, Python®, and Visual Basic®.

Data exchanged between network 10, visual display device(s) 2, edge device(s) 3, server(s) 4, and/or analysis device(s) 5 may include operational parameters of network 10, visual display device(s) 2, edge device(s) 3, server(s) 4, and/or analysis device(s) 5. Network 10, edge device(s) 3, server(s) 4, and/or analysis device(s) 5 may transmit data, including computer-readable instructions, to visual display device(s) 2. Visual display device(s) 2 may receive and implement the computer-readable instructions. In some embodiments, the computer-readable instructions, when implemented by visual display device(s) 2, may control visual display device(s) 2 to change one or more operational parameters, export collected data, etc. In an illustrative example, processing circuitry 43 may transmit an instruction to visual display device(s) 2 which requests visual display device(s) 2 to export collected data (e.g., first data times/second data items) to network 10, edge device(s) 3, server(s) 4, and/or analysis device(s) 5. In turn, network 10, edge device(s) 3, server(s) 4, and/or analysis device(s) 5 may receive the collected data from visual display device(s) 2 and store the collected data, for example, in storage device 22, 32, 42, or 52.

In embodiments, the computer-readable instructions, when implemented by analysis device(s) 5, may control analysis device(s) 5 to change one or more operational parameters, export collected data, etc. In an illustrative example, processing circuitry 43 may transmit an instruction to analysis device(s) 5 which requests analysis device(s) 5 to export collected data (e.g., sequence data) to network 10, edge device(s) 3, server(s) 4, and/or visual display device(s) 2. In turn, network 10, visual display device(s) 2, edge device(s) 3, and/or server(s) 4 may receive the collected data from analysis device(s) 5 and store the collected data, for example, in storage device 22, 32, 42, or 52.

In embodiments, processing circuitry 23 is described as performing the various processing techniques proscribed to visual display device(s) 2, but it should be understood that at least some of these techniques may also be performed by other processing circuitry (e.g., processing circuitry 53 of analysis device(s) 5, processing circuitry 43 of webserver(s) 4, processing circuitry 33 of edge device(s) 3, etc.). In an illustrative example, processing circuitry 23 may capture image(s) of a region of interest site, sample boundary site information, sample scale information and/or obtain other data set items, output images, and in some embodiments, transmit the post-processing report to another device.

Processing circuitry 43 may include one or more processors that are configured to implement functionality and/or process instructions for execution within webserver(s) 4. For example, processing circuitry 43 are capable of processing instructions stored by storage device 42. Processing circuitry 43 may include, for example, microprocessors, DSPs, ASICs, FPGAs, or equivalent integrated or discrete logic circuitry, or a combination of any of the foregoing devices or circuitry. Accordingly, processing circuitry 43 may include any suitable structure, whether in hardware, software, firmware, or any combination thereof, to perform the functions ascribed herein to processing circuitry 43. Processing circuitry 43 of webserver(s) 4 by itself or in conjunction with other processing circuitry 23, 33 and/or 53 may implement any of the techniques described herein to collect and analyze the region of interest boundary selection/sample boundary/sample scale selection and user input data.

In embodiments, the processing circuitry 43 may implement image processing with respect to the sample image, or the region of interest boundary selection, the sample boundary selection, or the sample scale selection. In some embodiments, processing circuitry 43 may include AI engine(s) 45 and/or ML model(s) 46 (not shown). In some embodiments, ML model(s) 46, 36, 26, 36, 46 may include one or more DL models that are trained, for example, on various region of interest boundary selections, sample boundary selections, sample scale selections and/or user input data. In some embodiments, processing circuitry 23, 33, 43 and/or 53 may utilize orientation information in order to adjust image processing parameters, for example, to align the sample when it is being assessed by the analysis device(s) 5 and/or extract a portion of sample from the sample that corresponds to the region of interest selection in the sample image for analysis by the analysis device(s) 5. In some embodiments, the region of interest size selection corresponds to the analysis device's analysis region (punchout or cutting device). For example, Singular Genomics uses 4.5 mm×4.5 mm, 10 mm×10 mm, or 10 mm×17 mm punch devices and the region of interest size selector tool may correspond to the punch device dimensions. In embodiments, the region of interest size selector tool may correspond to the punch device dimensions. In embodiments, the region of interest size selector tool corresponds to a circular shape including a diameter. In embodiments, the diameter is 6.5 mm, 44 mm, 16 mm, 22 mm, or 40 mm. In embodiments, the diameter is about 4 mm to about 50 mm. In embodiments, the diameter is about 3 mm to about 10 mm. In embodiments, the region of interest size selector tool corresponds to a square shape including a width and length, wherein the width and length are equal. In embodiments the width is 4.5 mm, 6.5 mm, 8 mm, 10 mm, or 11 mm. In embodiments, the width is about 4 mm to about 10 mm. In embodiments, the region of interest size selector tool corresponds to a rectangular shape including a width and length, wherein the width and length are not equal. In embodiments, the width is about 10 mm or about 15 mm. In embodiments, the length is about 17 mm or about 36 mm. In embodiments, the width is about 20 mm and the length is about 30 mm.

In some embodiments, processing circuitry 43 or 23 may provide a region of interest selection session configured to allow a user to navigate a plurality of sub-sessions comprising at least a first image processing sub-session and a second data processing sub-session that is distinct from the first image processing sub-session, where the first image processing sub-session comprises, consists, or consists essentially of capturing sample image via one or more cameras 62. In some embodiments, processing circuitry 43 or 23 may provide a region of interest selection session configured to allow a user to navigate a plurality of sub-sessions comprising at least a first image processing sub-session where the first image processing sub-session comprises, consists, or consists essentially of capturing sample image via one or more cameras 62, and receive from the user a region of interest boundary selection.

In some embodiments, processing circuitry 43 may provide the region of interest selection session through cloud solutions. In some embodiments, processing circuitry 43 or 23 may provide the region of interest selection session based on a scanning of a QR code from a flyer in a kit for sample collection.

In some embodiments, processing circuitry, e.g., processing circuitry 23 of visual display device(s) 2, processing circuitry 33 of edge device(s) 3, processing circuitry 43 of data webserver(s) 4, or processing circuitry 53 of analysis device(s) 5 may provide the region of interest selection session, including a first sub-session, a second sub-session, a third sub-session, and a fourth sub-session. The third sub-session may comprise a third set of data items and the fourth sub-session may comprise a fourth set of data items which are distinct from one another and distinct from the first and second set of date items.

In some embodiments, processing circuitry, e.g., processing circuitry 23 of visual display device(s) 2, processing circuitry 33 of edge device(s) 3, processing circuitry 43 of data webserver(s) 4, or processing circuitry 53 of analysis device(s) 5 may allow AI engine(s) 45, 35, 25, 35 (not shown but part of the edge device), 45 (not shown but part of the webserver), or 55 (not shown but part of the analysis device) (e.g., inference engines) and/or ML model(s) 46, 36, 26, 36 (not shown but part of the edge device), 46 (not shown but part of the webserver) or 56 (not shown but part of the analysis device) to provide trend-based analysis. In some embodiments, processing circuitry, e.g., processing circuitry 23 of visual display device(s) 2, processing circuitry 33 of edge device(s) 3, processing circuitry 43 of data webserver(s) 4, or processing circuitry 53 of analysis device(s) 5 may deploy AI engine(s) 45, 35, 25, 35, 45 or 55 (e.g., inference engines) and/or ML model(s) 46, 36, 26, 36, 46 or 56 configured to evaluate images based on historical frames of sample image to fit a trend line, rather than evaluating images based on a snapshot (e.g., single still-image) or even based on successive snapshots. In some embodiments, processing circuitry, e.g., processing circuitry 23 of visual display device(s) 2, processing circuitry 33 of edge device(s) 3, processing circuitry 43 of data webserver(s) 4, or processing circuitry 53 of analysis device(s) 5 may deploy AI engine(s) 45, 35, 25, 35, 45 or 55 (e.g., inference engines) and/or ML model(s) 46, 36, 26, 36, 46 or 56 configured to evaluate images based on a baseline characteristic(s). In any case, such an evaluation may inform a technician how to align the sample with the analysis device or where to extract a portion of sample from the sample that corresponds to the region of interest selection in the sample image for analysis by the analysis device(s) 5. In some embodiments, processing circuitry may enable a preprocessing algorithm to automatically adjust captured images to scale and orientation. In some embodiments, the size and shape of the region of interest boundary selection corresponds (same size/same shape) as the sample size that will be analyzed by the analysis device. For example, the region of interest boundary selection corresponds to the sample punchout in terms of size and shape used by the analysis device.

### III. Methods

The methods described herein provide for the ability to view spatial genomics data and proteomics data in the original context of one or more microscope images of a biological sample. In general, this disclosure is directed to a browser interface or a mobile device app that can be operated via a variety of user-facing visual display devices, including, but not limited to, a computer, a smartphone, tablet computer, PDAs, mobile device, etc., and other mobile visual display devices. The visual display device may execute a software application or access a website that causes the visual display device to perform various functionalities described herein either locally, using the computing resources of the visual display device, or via cloud computing, such as by transmitting user identified region of interest selection session data via a network interface to a backend system (e.g., a server system) that performs some or all of the techniques/analysis described herein, or both.

### Processing a Sample

Disclosed is a method of processing a sample, the method including: providing by a region of interest system, a region of interest selection session configured to allow a user to navigate a plurality of sub-sessions comprising at least a first image processing sub-session and a second data processing sub-session, wherein the first image processing sub-session comprises, consists, or consists essentially of capturing a first set of data items the first set of data items comprising a sample image and region of interest selection by the user and the second data processing sub-session comprises, consists, or consists essentially of a second set of data items the second set of data items comprising user defined information; transferring by the region of interest system the first set of data items and first set of data items to an analysis device or technician running an analysis device; detecting fluorescent labels (e.g., sequencing labeled nucleotides or detecting fluorescently labeled probes) by the region of interest system the sample based at least in part on the first set of data items and second set of data items; and outputting by the region of interest system a post-processing report based at least in part on the first set of data items and second set of data items. It is understood that the providing step can be performed by the region of interest system or by one or more of edge device(s) 12, network 10, server(s) 4, and/or visual display device(s) 2. It is understood that the transferring step can be performed by the region of interest system or by one or more of edge device(s) 12, network 10, server(s) 4, visual display device(s) 2 and/or analysis device(s) 5. It is understood that the detection step can be performed by the region of interest system or by the analysis device(s) 5. For example, the detection step may be completed by a nucleic acid sequencing device (e.g., G4X Spatial Sequencing platform). It is understood that the outputting step can be performed by the region of interest system or by one or more of edge device(s) 12, network 10, server(s) 4, visual display device(s) 2 and/or analysis device(s) 5.

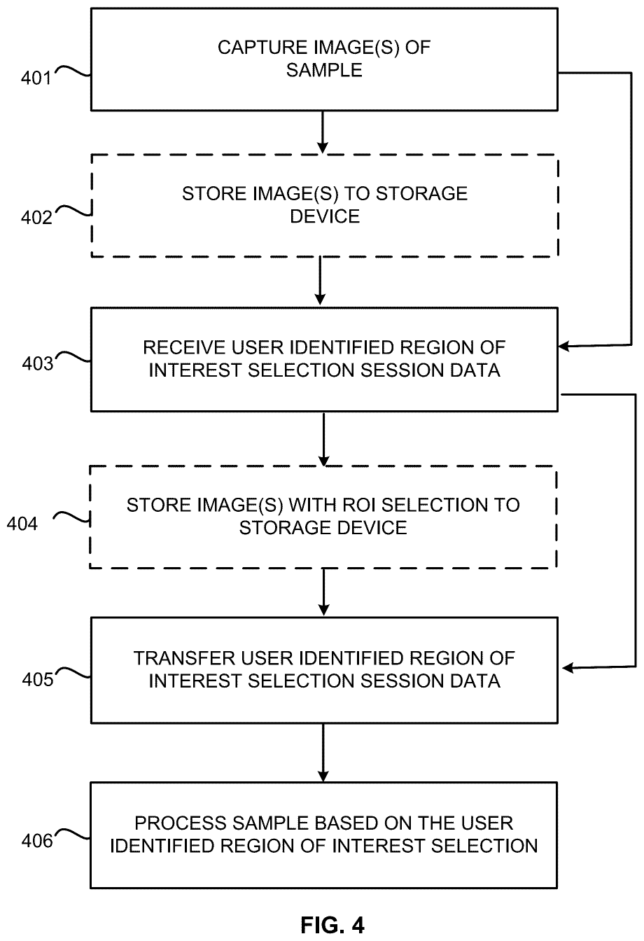

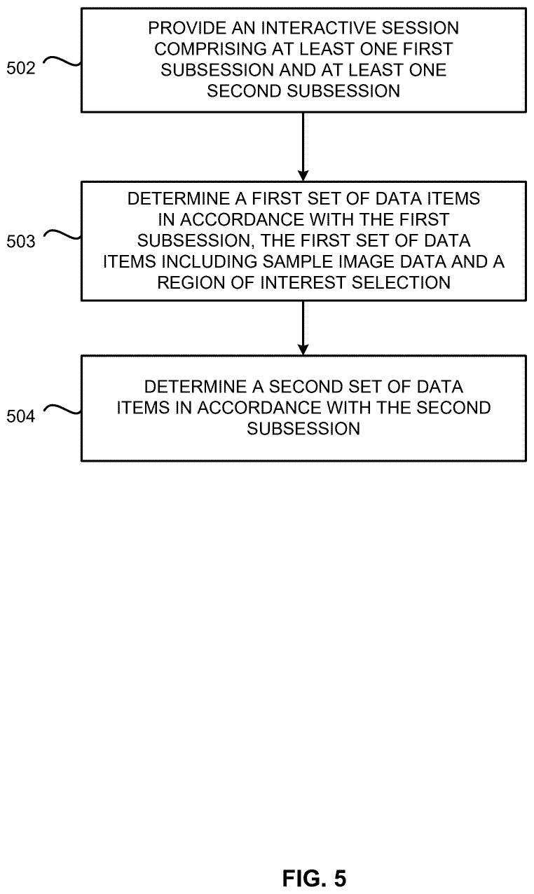

FIG. 5 is a flowchart illustrating an example method of navigating a set of UI interfaces of a region of interest selection process (e.g., a region of interest selection session), in accordance with one or more techniques of this disclosure. FIG. 4 is a flowchart illustrating an example method of navigating a set of UI interfaces of a region of interest selection process (e.g., a region of interest selection session), in accordance with one or more techniques of this disclosure. At Step 401, processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) receives (download from another device or taken with an integrated camera 62 on the visual display device(s) 2) a sample image representing the sample. In some embodiments, the sample image is stored (step 402) to the visual display device(s) 2, edge device(s) 3, and/or server(s) 4.

In some embodiments, the sample image comprises, consists, or consists essentially of a tissue image with a scale for ROI selection, H&E image of the tissue or both. In some embodiments, in step 403 processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) receives a user identified region of interest selection session data. In some embodiments, in step 404 processing circuitry 23, 33, or 43 stores the ROI selection to a storage device 22, 32, or 42. In some embodiments, in step 405 processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) optionally transfers user identified region of interest selection session data to a network 10 or analysis device(s) 5. In some embodiments, optionally in step 405a (not shown) a portion of the sample is extracted which corresponds to the region of interest boundary selection or analysis device(s) 5 is aligned with the user identified region of interest selection and/or a portion of sample from the sample that corresponds to the region of interest selection in the sample image is extracted from the sample for analysis. In some embodiments, optionally in step 406 processing circuitry 53 of analysis device(s) 5 analyzes the sample or potion of sample that corresponds to the region of interest boundary selection (by either analyzing the extracted portion of sample or the aligned portion of sample). In some embodiments, optionally in step 407 (not shown) processing circuitry 53 of analysis device(s) 5 exports a report based at least in part on the user identified region of interest selection.

### Capturing a Sample Image

In some embodiments, the sample is a tissue image without a marker of scale, a tissue image with a marker of scale (for example, a ruler), an image of the hydrogel block with FFPE tissue and combinations thereof. In embodiments, the sample is an FFPE tissue image. In embodiments, the sample is a fresh-frozen tissue image. In embodiments, the sample is isolated. The sample may be any material obtained from a subject for analysis using any of a variety of techniques including, but not limited to, biopsy, surgery, and laser capture microscopy (LCM), and generally includes cells and/or other biological material from the subject. In embodiments, a biological sample can also be obtained from non-mammalian organisms (e.g., plants, insects, arachnids, nematodes, fungi, amphibians, and fish. A biological sample can be obtained from a prokaryote such as a bacterium, e.g., Escherichia coli, Staphylococci or Mycoplasma pneumoniae; archaea; a virus such as Hepatitis C virus or human immunodeficiency virus; or a viroid. A biological sample can also be obtained from a eukaryote, such as a patient derived organoid (PDO) or patient derived xenograft (PDX). The biological sample can include organoids, a miniaturized and simplified version of an organ produced in vitro in three dimensions that shows realistic micro-anatomy. Organoids can be generated from one or more cells from a tissue, embryonic stem cells, and/or induced pluripotent stem cells, which can self-organize in three-dimensional culture owing to their self-renewal and differentiation capacities. In some embodiments, an organoid is a cerebral organoid, an intestinal organoid, a stomach organoid, a lingual organoid, a thyroid organoid, a thymic organoid, a testicular organoid, a hepatic organoid, a pancreatic organoid, an epithelial organoid, a lung organoid, a kidney organoid, a gastruloid, a cardiac organoid, or a retinal organoid. Subjects from which biological samples can be obtained can be healthy or asymptomatic individuals, individuals that have or are suspected of having a disease (e.g., cancer) or a pre-disposition to a disease, and/or individuals that are in need of therapy or suspected of needing therapy.

In embodiments, the sample can include any number of macromolecules, for example, cellular macromolecules and organelles (e.g., mitochondria and nuclei). The biological sample can include nucleic acids and/or proteins. The biological sample can include carbohydrates or lipids. The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, bone sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions and/or disaggregated cells. In embodiments, the sample can also include immune cells. Sequence analysis of the immune repertoire of such cells, including genomic, proteomic, and cell surface elements, can provide a wealth of information to facilitate an understanding the status and function of the immune system. Examples of immune cells in a biological sample include, but are not limited to, B cells, T cells (e.g., cytotoxic T cells, natural killer T cells, regulatory T cells, and T helper cells), natural killer cells, cytokine induced killer (CIK) cells, myeloid cells, such as granulocytes (basophil granulocytes, eosinophil granulocytes, neutrophil granulocytes/hyper-segmented neutrophils), monocytes/macrophages, mast cells, thrombocytes/megakaryocytes, and dendritic cells.

In some embodiments, capturing the image comprises capturing a tissue image with a marker scale for ROI selection, and/or capturing an H&E image of tissue. When more than one image is taken, it is of the same tissue sample (different tissue sample images are not collected in a single region of interest selection session). As such, capturing the image comprises capturing tissue with scale for ROI selection, and H&E image of the same tissue. In embodiments, an image is obtained in any electronic image file format, including but not limited to JPEG/JFIF, TIFF, Exif, PDF, EPS, GIF, BMP, PNG, PPM, PGM, PBM, PNM, WebP, HDR raster formats, HEIF, BAT, BPG, DEEP, DRW, ECW, FITS, FLIF, ICO, ILBM, IMG, PAM, PCX, PGF, JPEG XR, Layered Image File Format, PLBM, SGI, SID, CD5, CPT, PSD, PSP, XCF, PDN, CGM, SVG, PostScript, PCT, WMF, EMF, SWF, XAML, and/or RAW. In embodiments, the image is a color image (e.g., 3×8 bit, 2424×2424 pixel resolution). In embodiments, the image is a monochrome image (e.g., 14 bit, 2424×2424 pixel resolution). In embodiments, the image is obtained in any electronic color mode, including but not limited to grayscale, bitmap, indexed, RGB, CMYK, HSV, lab color, duotone, and/or multichannel.

The sample image may comprise, consists, or consists essentially of a single image. In some embodiments, the sample image comprises, consists, or consists essentially of a first set of images, the first set of images comprises, consists, or consists essentially of a plurality of images. In some embodiments, the sample image may comprise, consists, or consists essentially of a second set of images. The second set of images comprises, consists, or consists essentially of a single image or a plurality of images. Processing circuitry 23, 33, 43 and/or 53 may perform a validation of the sample image, the first set of images and/or second set of images. In some embodiments, processing circuitry 23, 33, 43 and/or 53 discards images that fail the validation test. In some embodiments, processing circuitry 23, 33, 43 and/or 53 identify whether images are captured according to a particular orientation (e.g., portrait, landscape, angled, etc.), and may prompt the user, via UI 44, when identifying an image captured at an improper orientation, to capture images according to the desired orientation. In some embodiments, processing circuitry 23, 33, 43 and/or 53 may identify objects, via object recognition, and notify a user, via UI 44, when a sample image has an improper object, i.e., a portion of the sample image is blocked by the ruler.

In embodiments, an image is a bright-field microscopy image, in which the imaged sample appears dark on a bright background. In some such embodiments, the sample has been stained. For instance, in some embodiments the sample has been stained with Haemotoxylin and Eosin and the image is a bright-field microscopy image. In some embodiments the sample has been stained with a Periodic acid-Schiff reaction stain (stains carbohydrates and carbohydrate rich macromolecules a deep red color) and the image is a bright-field microscopy image. In some embodiments the sample has been stained with a Masson's trichrome stain (nuclei and other basophilic structures are stained blue, cytoplasm, muscle, erythrocytes and keratin are stained bright-red, collagen is stained green or blue, depending on which variant of the technique is used) and the image is a bright-field microscopy image. In some embodiments the sample has been stained with an Alcian blue stain (a mucin stain that stains certain types of mucin blue, and stains cartilage blue and can be used with H&E, and with van Gieson stains) and the image is a bright-field microscopy image. In embodiments the sample has been stained with a van Gieson stain (stains collagen red, nuclei blue, and erythrocytes and cytoplasm yellow, and can be combined with an elastin stain that stains elastin blue/black) and the image is a bright-field microscopy image. In embodiments the sample has been stained with a reticulin stain, an Azan stain, a Giemsa stain, a Toluidine blue stain, an isamin blue/eosin stain, a Nissl and methylene blue stain, and/or a sudan black and osmium stain and the image is a bright-field microscopy image. In embodiments, the sample has been stained with an immunofluorescence (IF) stain (e.g., an immunofluorescence label conjugated to an antibody). To facilitate visualization, biological samples can be stained using a wide variety of stains and staining techniques. In some embodiments, for example, a sample can be stained using any number of biological stains, including but not limited to, acridine orange, Bismarck brown, carmine, Coomassie blue, cresyl violet, DAPI, eosin, ethidium bromide, acid fuchsine, hematoxylin, Hoechst stains, iodine, methyl green, methylene blue, neutral red, Nile blue, Nile red, osmium tetroxide, propidium iodide, rhodamine, safranin, or a combination thereof. In some embodiments, the sample is stained using a detectable label (e.g., radioisotopes, fluorophores, chemiluminescent compounds, bioluminescent compounds, and dyes). In some embodiments, a biological sample is stained using only one type of stain or one technique. In some embodiments, staining includes biological staining techniques such as H&E staining. In some embodiments, staining includes identifying analytes using fluorescently-labeled antibodies. In some embodiments, a biological sample is stained using two or more different types of stains, or two or more different staining techniques. For example, a biological sample can be prepared by staining and imaging using one technique (e.g., H&E staining and bright-field imaging), followed by staining and imaging using another technique (e.g., IHC/IF staining and fluorescence microscopy) for the same biological sample. In some embodiments, biological samples can be destained. Methods of destaining or discoloring a biological sample are known in the art, and generally depend on the nature of the stain(s) applied to the sample. For example, H&E staining can be destained by washing the sample in HCl, or any other low pH acid (e.g., selenic acid, sulfuric acid, hydroiodic acid, benzoic acid, carbonic acid, malic acid, phosphoric acid, oxalic acid, succinic acid, salicylic acid, tartaric acid, sulfurous acid, trichloroacetic acid, hydrobromic acid, hydrochloric acid, nitric acid, orthophosphoric acid, arsenic acid, selenous acid, chromic acid, citric acid, hydrofluoric acid, nitrous acid, isocyanic acid, formic acid, hydrogen selenide, molybdic acid, lactic acid, acetic acid, carbonic acid, hydrogen sulfide, or combinations thereof). In some embodiments, destaining can include 1, 2, 3, 4, 5, or more washes in a low pH acid (e.g., HCl). In some embodiments, destaining can include adding HCl to a downstream solution (e.g., permeabilization solution). In some embodiments, destaining can include dissolving an enzyme used in the disclosed methods (e.g., pepsin) in a low pH acid (e.g., HCl) solution. In some embodiments, after destaining hematoxylin with a low pH acid, other reagents can be added to the destaining solution to raise the pH for use in other applications. For example, SDS can be added to a low pH acid destaining solution in order to raise the pH as compared to the low pH acid destaining solution alone. As another example, in some embodiments, one or more immunofluorescence stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer.

### Providing a Region of Interest Selection Session

In some embodiments, the disclosure provides a method of receiving a sample for analysis, the method comprising: providing by a region of interest system, a region of interest selection session configured to allow a user to navigate a plurality of sub-sessions comprising at least a first image processing sub-session and at least a second data processing sub-session, wherein the first image processing sub-session comprises, consists, or consists essentially of capturing sample image(s) and allowing a user to apply a region of interest boundary that defines a at least one region of interest defined by the user and/or apply a sample boundary that defines the sample boundary defined by the user and/or apply a sample scale that defines the sample scale defined by the user and wherein the second data processing sub-session comprises, consists, or consists essentially of receiving user-input data. In some embodiments, the sample is optionally analyzed based on at least the region of interest selection session data. In some embodiments, a sample result is based on at least the region of interest selection session data.

### The Region of Interest Selection Session

The region of interest selection module, as disclosed herein, represents a significant technological advance over prior implementations. Specifically, the disclosed techniques can receive and display a tailored set of user-identified boundary defining a region of interest in a sample, user-identified sample boundaries, user-identified scale information and user input data, resulting in an increased efficiency in accessing the relevant region of interest quickly and allowing technicians and/or the analysis device to align the analysis device over a region of interest in a sample based on the user-identified region of interest selection. Generally, this is accomplished by displaying to a user multiple user-related content elements (e.g., content tiles, sub-session interfaces, etc.). Further, the disclosed techniques can yield analysis result benefits by allowing the user to select the region of interest boundary by using specific tools that are deployed and implemented in order to achieve the highest accuracy of sample region of interest selection.

In some embodiments, the region of interest selection session comprises, consists, or consists essentially of a fist image processing sub-session, a second data processing sub-session or both. In some embodiments, the region of interest selection session comprises, consists, or consists essentially of a third and/or a fourth sub-session and/or nth sub-session (where nth represents any number 5-100) as described herein. In some embodiments, the region of interest selection session comprises, consists, or consists essentially of a plurality of sub-sessions. In some embodiments, the region of interest selection session comprises, consists, or consists essentially of only one sub-session.

FIG. 3 is an UI visualization of a region of interest selection session interface 409, in accordance with one or more techniques of this disclosure. Upon initiation of the region of interest selection session, visual display device 2 may output, via webserver 4 and processing circuitry 43, an interactive UI 44 called the region of interest selection session. In some embodiments, processing circuitry 43 may provide a top-level interface that comprises, consists, or consists essentially of at least one first interface tile 407. The first interface tile may correspond to a top-level region of interest selection session or the first image processing sub-session interface. In such instances, the first image processing sub-session interface may include at least an initial sub-interface of the first sub-interface level that is at a same level relative to a level of the top-level interface.

In some embodiments, the top-level UI 44 interface comprises, consisting of, or consisting essentially of a region of interest selection interface 407 and a report interface 410 that presents a plurality of tiles (a region of interest selection interface tile and/or report interface tile) from which the user can choose.

As shown in FIG. 3, the UI elements of interface 409 may include a region of interest selection session tile 407. The region of interest selection session interface may include a first image processing sub-session tile and a second data processing sub-session tile. The first image processing sub-session interface may include an initial sub-session tile and one or more subsequent sub-session region of interest selection session tile(s). In some embodiments, there are separate initial sub-session interfaces and subsequent sub-session region of interest selection session interfaces(s).

In addition, the top-level interface may include a report interface tile 410. In some embodiments, webserver 4, network 10 and/or edge device(s) 3 may download or export reports to the visual display device 2 in response to a detected selection of an export report tile. The exported reports may include multiple reports (e.g., multiple sub-session reports detailing an analysis of a plurality of data items from a plurality of sub-sessions) or compilation reports (e.g., reports detailing an analysis of a plurality of samples).

While described as being provided as part of a hierarchal structure with tiered-levels, it will be understood that the techniques of this disclosure are not so limited. In some embodiments, the sub-session interfaces are described as separate from a top-level region of interest selection session interface in terms of what a user may see as a default when initialing receiving the session interfaces. In some embodiments, the UI 44 or 24 may present all interfaces at a single level, where a user may access each individual sub-session interface from the top-level interface. In some embodiments, a user may access and/or initiate a sub-session from the top-level interface. In some embodiments, a user may access and/or initiate a sub-session from another sub-session interface.

In some embodiments, once the first image processing sub-session is complete, the UI 44 or 24 may revert to a separate user interface (e.g., the top-level, menu interface or a subsequent sub-session interface of the first/second data processing sub-session). While several examples are described herein for user interaction with the interactive sub-session of this disclosure, it will be understood that the interactive sub-session are provided in various contexts not necessarily described herein for sake of brevity.

In some embodiments, the processing circuitry 23, 33, and/or 43 stores region of interest selection session information (e.g., first sub-session information, second sub-session information, and/or combined session information, etc.) and results of previous sessions (e.g., locally at the visual display device storage 22, to a cloud storage 42, to an edge device storage 32, or combinations thereof). In some embodiments, previous sessions are stored to assist the user and/or to track a user's preferences or with respect to typical regions of interest for purposes of building an AI and/or Machine Learning tool.

In some embodiments, the region of interest selection session includes sub-sessions that are tailored to the sample or user.

### First Image Processing Sub-session

FIG. 5 is a flowchart illustrating an example method of navigating a region of interest selection session 502. In some embodiments, the one or more sub-sessions include at least a first image processing sub-session 503 and a second data processing sub-session 504. In some embodiments, the second data processing sub-session is distinct from the first image processing sub-session. In some embodiments, the second data processing sub-session is not distinct from the first image processing sub-session.

In some embodiments, the first image processing sub-session comprises, consists, or consists essentially of capturing sample image(s) via one or more image sensors or cameras 62 (the camera can be on or off the visual display device). In some embodiments, the first image processing sub-session comprises, consists, or consists essentially of uploading sample image(s) stored on the visual display device 2. In some embodiments, processing circuitry 23 of visual display device(s) 2, processing circuitry 33 of edge device(s) 3, processing circuitry 43 of webserver(s) 4 (but not processing circuitry 53 of analysis device(s) 5) provides a prompt for the user 4 to utilize the one or more cameras 62 to capture one or more images of the sample and/or a prompt for the user 4 to upload one or more stored images (stored on the visual display device or stored on a mobile device connected to the visual display device) of the sample.

In some embodiments, processing circuitry 23 of visual display device(s) 2, processing circuitry 33 of edge device(s) 3, processing circuitry 43 of webserver(s) 4 (but not processing circuitry 53 of analysis device(s) 5) stores the sample image as the sample image (un-edited) prior to allowing a user to apply a region of interest boundary, a sample boundary and/or sample scale. In some embodiments, processing circuitry 23 of visual display device(s) 2, processing circuitry 33 of edge device(s) 3, processing circuitry 43 of webserver(s) 4 does not store the sample image prior to allowing the user to apply a region of interest boundary, a sample boundary and/or sample scale.

In some embodiments, processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) identify a first set of data images in accordance with the first image processing sub-session of the region of interest selection session after the user applies a region of interest boundary, a sample boundary, and/or sample scale.

In some embodiments, a user applies a region of interest boundary, a sample boundary, and/or sample scale by selecting a boundary tile displayed in the first image processing sub-session interface of the region of interest selection session. In some embodiments, the boundary tile has a predefined shape (e.g., circular, rectangular, or square). In some embodiments, the user drags and drops the predefined shape over the sample image(s) to define a region of interest boundary, a sample boundary, and/or sample scale. In some embodiments, the boundary tile further has a predefined size. In some embodiments, the boundary tile does not have a predefined size and the user can increase or decrease the size/volume of the boundary. In some embodiments, the boundary tile is a square, rectangle, triangle or circle. In some embodiments, the boundary tile allows the user to draw a boundary of any shape or size around the region of interest/sample. In some embodiments, the boundary tile allows the user to drop edge point locations around the region of interest/sample and the processing circuitry connects the dots to define a boundary. In some embodiments, the boundary tile for the region of interest selection is the same as the boundary tile for the sample boundary selection and, in some embodiments, they are different. In some embodiments, the tile for the start sample scale is different than the tile for the end sample scale. In some embodiments, the tile for the start sample scale is the same as the tile for the end sample scale.

In some embodiments, processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) receive a plurality of region of interest selections to define a single transferred region of interest selection and only the transferred region of interest selection is transferred. In some embodiments, the transferred region of interest selection and the plurality of region of interest selections are transferred. In some embodiments, processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) receive a plurality of sample boundary selections to define a single transferred sample boundary selection and only the transferred sample boundary selection is transferred. In some embodiments, the transferred sample boundary selection and the plurality of sample boundary selections are transferred. In some embodiments, processing circuitry, e.g., processing circuitry 23 of visual display device(s) 2, processing circuitry 33 of edge device(s) 3, processing circuitry 43 of webserver(s) 4, (but not processing circuitry 53 of analysis device(s) 5) receive a plurality of sample scale selections to define a single transferred sample scale selection and only the transferred sample scale selection is transferred. In some embodiments, the transferred sample scale selection and the plurality of sample scale selections are transferred.

In some embodiments, the region of interest boundary selection and/or sample boundary selection and/or sample scale selection are an augmented reality overlay. Processing circuitry 23 of visual display device(s) 2, processing circuitry 33 of edge device(s) 3, processing circuitry 43 of webserver(s) 4, (but not processing circuitry 53 of analysis device(s) 5) outputs the region of interest boundary selection and/or sample boundary selection and/or sample scale selection as part of the user identified region of interest selection session data.

In some embodiments, the first set of data images include an image overlay (e.g., an augmented reality overlay). The image overlay is used to augment a set of sample images to define for example a reference point. In some embodiments, processing circuitry 23 of visual display device(s) 2, processing circuitry 33 of edge device(s) 3, processing circuitry 43 of webserver(s) 4, (but not processing circuitry 53 of analysis device(s) 5) may output the image overlay as part of the user identified region of interest selection session data.

In addition, when providing the first image processing sub-session, processing circuitry 23 of visual display device(s) 2, processing circuitry 33 of edge device(s) 3, or processing circuitry 43 of webserver(s) 4 (but not processing circuitry 53 of analysis device(s) 5) may detect selection of a first interface tile and provide the initial sub-session of the region of interest selection session. In some embodiments, when providing the first image processing sub-session of the region of interest selection session, processing circuitry 23 of visual display device(s) 2, processing circuitry 33 of edge device(s) 3, or processing circuitry 43 of webserver(s) 4, may detect selection of a second interface tile, and provide the subsequent sub-session of the region of interest selection session. In some embodiments, there is a plurality of subsequent sub-session(s) of the region of interest selection session. In some embodiments, there is only an initial sub-session of the first image processing sub-session of the region of interest selection session. In some embodiments, there is an initial sub-session and subsequent sub-session(s) of the first image processing sub-session of the region of interest selection session. In some embodiments, once the initial sub-session of the first image processing sub-session is complete, visual display device 2 may revert to a separate user interface (e.g., the top-level, menu interface or a subsequent sub-session interface or a second data processing sub-session interface).

In some embodiments, processing circuitry 23, 33, or 43 upon selection of the subsequent interface tile, modifies the initial interface tile to indicate completion of the initial sub-session of the first image processing sub-session of the region of interest selection session (e.g., with a checkmark or gray out). In some embodiments, processing circuitry 23, 33, or 43 upon selection of the second interface tile, modifies the first interface tile to indicate completion of the first sub-session of the first image processing sub-session of the region of interest selection session (e.g., with a checkmark or gray out). In some embodiments, the initial interface tile of the first sub-session and subsequent interface tile of the first sub-session are different.

In some embodiments, selection of the first interface tile displays an initial sub-session interface tile and at least one subsequent sub-session interface tile. In some embodiments, for the convenience of user navigation, processing circuitry 23, 33, or 43 may facilitate navigation from the initial sub-session of the first region of interest selection session to a subsequent sub-session of the first image processing sub-session of the region of interest selection session without involving a top-level interface.

In some embodiments, for the convenience of user navigation, processing circuitry 23, 33, or 43 may facilitate navigation from the first image processing sub-session of the region of interest selection session to a second data processing sub-session of the region of interest selection session without involving a top-level interface.

In any case, processing circuitry 23, 33, or 43 may also provide, subsequent to the first image processing sub-session or the second data processing sub-session, a third sub-session of the region of interest selection session that identify a third set of data items in accordance with the third sub-session of the region of interest selection session, where the third set of data items is distinct from the sample image. It should be noted that the sub-sessions described in this disclosure can be provided in any order and accessed in any order, and in some embodiments, processing circuitry 23, 33, or 43 may phase out one or more sub-sessions at particular periods of time.

In some embodiments, processing circuitry 23, 33, or 43 may disable access to an imaging sub-session for any reason or no reason. In some embodiments, processing circuitry 23, 33, or 43 may generate the region of interest selection session to include a disabled function (e.g., the sub-session is disabled by the processing circuitry) such that the disabled sub-session is hidden or otherwise inaccessible to the user. In some embodiments, processing circuitry 23, 33, or 43 may generate the region of interest selection session to include a skip function (e.g., the sub-session is skipped by the user, i.e., no data is entered or uploaded for the skipped sub-session by the user), but the skipped sub-session is shown and is otherwise accessible to the user.

In some embodiments, processing circuitry, e.g., processing circuitry 23 of visual display device(s) 2, processing circuitry 33 of edge device(s) 3, processing circuitry 43 of data webserver(s) 4 (but not processing circuitry 53 of analysis device(s) 5) may initiate the second data processing sub-session subsequent to the first image processing sub-session.

In some embodiments, the user uploads or takes a first set of sample image(s) during the first image processing sub-session (as part of the initial sub-session but not the subsequent sub-session). The first set of images may include a single image, or a plurality of images. In some embodiments, the user makes at least one region of interest boundary selection on a first image or on a first set of sample image(s) during the first image processing sub-session (as part of the initial sub-session or subsequent sub-session). In some embodiments, the user makes a sample boundary selection on a first image or on a first set of sample image(s) during the first image processing sub-session (as part of the initial sub-session or subsequent sub-session). In some embodiments, the user makes a sample scale selection on a first image or on a first set of sample image(s) during the first image processing sub-session (as part of the initial sub-session or subsequent sub-session).

In some embodiments, the user uploads or takes a sample image with a marker of scale and uploads an image of the same sample with an H&E image. In some embodiments, the user makes at least one region of interest boundary selection on the image with a marker of scale. In some embodiments, the user does not make a region of interest boundary selection on the H&E image. In some embodiments, prior to making the region of interest selection the user selects the scale of the image. The scale of the image is selected by clicking a start tile to set the start point and clicking an end tile to set the end point of the sample image with a marker scale. In some embodiments, the H&E image is not used to select a scale of the image.

In some embodiments, the region of interest selection only comprises sample. In some embodiments, the region of interest selection comprises sample and a region off the sample. In some embodiments, the region of interest selection only comprises sample within the start point and end point of the marker scale. In some embodiments, the region of interest selection comprises sample and a region outside the start point and end point of the marker scale.

In some embodiments, processing circuitry 23, 33, or 43 (but not 53) may identify a common alignment reference for aligning the first image in the first set of images with a second/subsequent image. In some embodiments, processing circuitry 23, 33, or 43 (but not 53) may align, according to the common alignment reference, a plurality of images from the first set of images. In some embodiments, processing circuitry 23, 33, or 43 (but not 53) may identify a common alignment reference for aligning the region of interest boundary, sample boundary, start point selection for scale, end point selection for scale, a feature in the H&E image and combinations thereof. In some embodiments, processing circuitry 23, 33, or 43 (but not 53) may validate images for quality (e.g., blurriness), orientation (e.g., portrait only), and may discard images that fail the validation test.

### Second Data Processing Sub-session

The second data processing sub-session is configured to elicit information from the user 4 about the sample that might be useful in assessing the sample. In some embodiments, the second data processing sub-session is designed to receive a second set of data items distinct from the first image processing sub-session. This is because the second data processing sub-session comprises, consists, or consists essentially of a sub-session configured to obtain complementary or supplemental data relative to the first image processing sub-session, rather than to serve as a duplicate of the first image processing sub-session. To illustrate, the second set of data items may include user-input data about the region of interest site, sample boundary, sample scale and/or about the sample.

In some embodiments, processing circuitry may identify, from parameters obtained via a second data processing sub-session, information that suggests an increase in the likelihood (e.g., probability, confidence interval) that a potential sequence is abnormal.

In some embodiments, processing circuitry 23, 33, or 43 (but not 53) may identify a second set of data items in accordance with the second data processing sub-session of the region of interest selection session. In some embodiments, the second set of data items is distinct from the first set of data items. In some embodiments, the second set of data items is not distinct from the first set of data items. In some embodiments, the second set of data items comprises, consists, or consists essentially of one or more of: user-input data where the user input data comprises a user selection from a drop-down menu and/or user defined information.

In some embodiments, the second data processing sub-session comprises, consists, or consists essentially of capturing user input data. In some embodiments, processing circuitry 23 of visual display device(s) 2, processing circuitry 33 of edge device(s) 3, processing circuitry 43 of webserver(s) 4, provides a prompt for the user 4 to input data and/or upload user input data. In some embodiments, the prompt for user input data is in the form of a drop-down in which the drop-down allows the user to select user input data from a pre-defined list of data. In some embodiments, the user input data defines information about the sample, the region of interest boundary, the sample boundary, the scale of the image and combinations thereof. In some embodiments, the user defined input data comprises, consists, or consists essentially of sample collection date, suspected abnormalities, information about where the sample was collected from, and combinations thereof. In some embodiments, the user defined input data comprises, consists, or consists essentially of name of the person entering the information, institute where the sample was collected, email of the user, phone of the user, purpose or goal of the study, date, detection information (detection modes and sequencing specifics), tissue information such as species, tissue type (organ such as breast, colon, or lymph tissue), FFPE blocks intended use, number of hydrogel blocks, and combinations thereof.

In some embodiments, the user enters user input data via text entry, dropdown menu selection from prepopulated responses, and/or radio buttons. In some embodiments, the UI may output questions, to elicit user responses by which the user could enter information such as sample date, collection time, as well as other prompted information.

In some embodiments, visual display device 2 stores the user input data. In some embodiments, visual display device 2 does not store the user input data. In some embodiments, user input data is stored by storage device 22, 32, or 42 but not 52.

In some embodiments, processing circuitry, e.g., processing circuitry 23 of visual display device(s) 2, processing circuitry 33 of edge device(s) 3, processing circuitry 43 of webserver(s) 4, identify a second set of data items in accordance with the second data processing sub-session of the region of interest selection session after the user inputs (manually or via a drop-down) user input data.

In addition, when providing the second data processing sub-session, processing circuitry 23 of visual display device(s) 2, processing circuitry 33 of edge device(s) 3, processing circuitry 43 of webserver(s) 4, (but not processing circuitry 53 of analysis device(s) 5), may detect selection of an initial interface tile, and provide the initial sub-session of the second sub-session interface. In some embodiments, the initial sub-session of the second interface comprises a location for a user to manually input data. In some embodiments, when providing the second data processing sub-session of the region of interest selection session, processing circuitry 23 of visual display device(s) 2, processing circuitry 33 of edge device(s) 3, processing circuitry 43 of webserver(s) 4, (but not processing circuitry 53 of analysis device(s) 5), may detect selection of a subsequent interface tile of the second data processing sub-session, and provide the subsequent sub-session of the second data processing sub-session region of interest selection session. In some embodiments, there is a plurality of subsequent sub-sessions of the second data processing sub-session of the region of interest selection session. In some embodiments, there is only an initial sub-session of the second data processing sub-session of the region of interest selection session. In some embodiments, once the initial sub-session of the second data processing sub-session is complete, the UI 44 or 24 may revert to a separate user interface (e.g., the top-level, menu interface or a subsequent sub-session interface or a second data processing sub-session interface or a subsequent sub-session). In some embodiments, the subsequent sub-session of the second interface comprises a drop-down menu for a user to select data.

In some embodiments, processing circuitry 23, 33, or 43 upon selection of the second interface tile, modifies the first interface tile to indicate completion of the first sub-session. In some embodiments, processing circuitry 23, 33, or 43 upon selection of the subsequent interface tile from the second sub-session, modifies the initial interface tile to indicate completion of the initial sub-session from the second sub-session. In some embodiments, the modification is a checkmark or gray out. In some embodiments, the first interface tile of the second sub-session and subsequent interface tile(s) of the second sub-session are different.

In some embodiments, selection of the first interface tile of the second sub-session displays an initial sub-session interface tile and at least one subsequent sub-session interface tile. In some embodiments, the initial sub-session interface tile of the second sub-session and at least one subsequent sub-session interface tile is different.

In some embodiments, for the convenience of user navigation, processing circuitry 23, 33, or 43 may facilitate navigation from the initial sub-session of the second sub-session region of interest selection session to a subsequent sub-session of the second sub-session of the region of interest selection session without involving a top-level interface.

In some embodiments, for the convenience of user navigation, processing circuitry 23, 33, or 43 may facilitate navigation from the first image processing sub-session of the region of interest selection session to a second data processing sub-session of the region of interest selection session without involving a top-level interface.

In some embodiments, the user uploads or enters a second set of data items during the second data processing sub-session. The user input data may include a file, manually inputted data, and/or selection from a dropdown menu.

In some embodiments, the user uploads or enters a first set of data items and a second set of data items into visual display device(s) 2. In some embodiments, the user may enter a first set of data items and a second set of data items via another visual display device 2 that may then transfer information to one of visual display device(s) 2 that is/are configured to operate an interactive session and are communicatively coupled to the webserver 4. In some embodiments, network 10, webserver 4 or edge device(s) 3 may facilitate the exchange of data between various visual display device(s) 2 and the analysis device(s) 5 or computing device of an expert technician (not shown).

It should be understood that the sub-sessions can be performed in various different sequences and with additional sub-session or without one or more of the sub-session described herein.

### Transferring the Sample Image and User Defined Information

In some embodiments, network 10, visual display device(s) 2, edge device(s) 3, server(s) 4, and/or analytical device(s) 5 facilitate the exchange of data between various network 10, visual display device(s) 2, edge device(s) 3, server(s) 4, and/or analytical device(s) 5 etc.

In some embodiments, visual display device(s) 2 transmits the various images to a secure backend system. Example backend systems include edge device(s) 3, webserver(s) 4, and/or other components of network 10. Processing circuitry of the backend system (e.g., processing circuitry 33, processing circuitry 43, etc.) may process the various images and/or route the user identified region of interest selection session data to various other devices such as to the analytical device(s) 5 or computing device of an expert technician (not shown). Processing circuitry 23, 33, or 43 may, in some embodiments, store user identified region of interest selection session data to storage device 50 of analysis device(s) 5 or computing device of an expert technician (not shown). Similarly, processing circuitry 23, 33, or 43 may store such data to storage device 32 of edge device(s) 3 or to storage device 42 of webserver(s) 4.

In some embodiments, the backend system may route the various user identified region of interest selection session data to a visual display device of an expert technician trained to align the analysis device with the region of interest selection made by the user. In some embodiments, the region of interest boundary selection is aligned with the sample and the technician takes a punch of the sample at the region of interest selection site and that punch is analyzed by the analysis device.

At the completion of the region of interest selection session (e.g., first image processing sub-session and second data processing sub-session), processing circuitry 23, 33, or 43 marks the first and second data set items with date and time stamps. In some embodiments, at the completion of the region of interest selection session the user generates a report (e.g., as a portable document format (PDF) or in various other formats such as EXCEL) for the input records (first and second data set items) of the user to email or otherwise transfer the report or select contents of the report to the visual display device or treating clinician.

In some embodiments, the user may save the input results locally to the visual display device (e.g., a smartphone or tablet computer) for future comparison, reference, or use as a standalone file. In some embodiments, the visual display device may store the results locally to the visual display device for use as a retrievable session within the app or other app. In some embodiments, the app may, in some non-limiting examples, push the report to a proprietary network (e.g., via an online portal). By pushing the report or other data in this way, the tools of this disclosure enable the backend device to review the user's selection and enter data into an electronic record or repository. In some embodiments, a confirmation of receipt by the backend device based on various criteria (and in some embodiments, an indication of whether the input report was reviewed by a technician) and provide this communication to the user via communication to the mobile device or other user-accessible computing modality. In some embodiments, the visual display device is configured to receive an indication as to whether the report was reviewed by the backend device or reviewed by a technician. In some embodiments, the visual display device is configured to provide, a user with a status of the report (e.g., input report reviewed, review in-progress, sequencing in progress, sequencing report available etc.).

In some embodiments, the visual display device transmits user identified region of interest selection session data (first set of data items and/or second set of data items) to a cloud, an internet of things (IoT) device or another visual display device used by the technician (not shown) and/or directly to the analytical/analysis device.

In some embodiments, visual display device(s) 2 may transmit the image and/or other data items to another device, such as webserver(s) 4, via network 10, in which case, webserver(s) 4 may transmit the image and/or other data items to edge device(s) 3 or the analysis device or a computing device of the technician (not shown) for analysis. In some embodiments, visual display device(s) 2 may transmit data to edge device(s) 3, which, in turn, performs processing of the user identified region of interest selection session data captured data and/or transmission of the user identified region of interest selection session data captured data to webserver(s) 4 or the analysis device or computing device of the technician for analysis.

In some embodiments, visual display device(s) 2, edge device(s) 3 and/or webserver(s) 4, computing device of the technician, and/or analysis device may receive the user identified region of interest selection session data from visual display device(s) 2. In some embodiments, visual display device(s) 2, edge device(s) 3 and/or webserver(s) 4 may perform an image processing analysis prior to transmitting user identified region of interest selection session data to the analysis device or computing device of the technician. In some embodiments, edge device(s) 3 or server(s) 4 may deploy image processing engine(s) (e.g., via AI engine(s) and/or ML model(s)). In some embodiments, edge device(s) 3 may perform some or all of the analysis with assistance from webserver(s) 4. That is, in some embodiments, webserver(s) 4 or edge device(s) 3 may include image processing engines or various analysis tools, configured to assist in the processing of image data. Server(s) 4 and/or edge device(s) 3 may include image processing engines, such as AI engine(s) or ML model(s). In some embodiments, webserver(s) 4 or edge device(s) 3 may include training sets for training one or more imaging processing engine(s). Server(s) 4 and/or edge device(s) 3 may perform the training of the image processing engine(s) or, in some embodiments, may assist visual display device(s) 2 with training the image processing engine(s). In some embodiments, server(s) and/or edge device(s) 3 may transmit training sets to visual display device(s) 2. In such instances, visual display device(s) 2 may train the image processing algorithms (e.g., via AI engine(s) 45, 35, 25 and/or ML models(s) 46, 36, 26). In any case, visual display device(s) 2, edge device(s) 3, and/or server(s) 4, may identify, from the images, the presence of a potential computer-generated region of interest site based on an analysis of the images.

In some embodiments, transferring user identified region of interest selection session data comprises, consists, or consists essentially of transferring, via communication circuitry 21, 31, 41 and/or 51, one or more frames of the sample image, one or more region of interest boundary selection, one or more sample boundary selection, one or more scale selections, one or more user input data.

### Alignment

In embodiments, the analysis device is aligned with the region of interest site. The analysis device may be automatic or manually aligned. The analysis device may be manually aligned with the region of interest boundary selection by the technician. In some embodiments, the technician takes a portion (smaller, same size or larger than the region of interest selection) of the region of interest selection and that portion is analyzed by the analyses device. In some embodiments the alignment algorithm is a robust point matching algorithm (See, for example, Chui and Rangarajanb, 2003, “A new point matching algorithm for non-rigid registration,” Computer Vision and Image Understanding 89(2-3), pp. 114-141, which is hereby incorporated by reference) or a thin-plate-spline robust point matching algorithm (See, for example, Yang, 2011, “The thin plate spline robust point matching (TPS-RPM) algorithm: A revisit,” Pattern Recognition Letters 32(7), pp. 910-918, which is hereby incorporated by reference.) In some embodiments the alignment algorithm is an iterative closest point algorithm. See, for example, Chetverikov et al., 2002, “the Trimmed Iterative Closest Point Algorithm,” Object recognition supported by user interaction for service robots, Quebec City, Quebec, Canada, ISSN: 1051-4651;and Chetverikov et al., 2005, “Robust Euclidean alignment of 3D point sets; the trimmed iterative closest point algorithm,” Image and Vision Computing 23(3), pp. 299-309, each of which is hereby incorporated by reference.

In some embodiments, the technician may extract a portion of sample from the sample that corresponds to the region of interest selection in the sample image for analysis. In some embodiments, a technician may perform such alignment by comparing a first image (sample image or region of interest boundary selection image) with the actual sample.

In some embodiments, a technician may point the detection device at the region of interest site by comparing the region of interest site image to the actual sample. In some embodiments, once the detection device is aligned, a sample status indicator may appear indicating a status of the sample, including the region of interest site and sample are aligned. In some embodiments, a technician may perform such alignment by comparing a first image (sample image or region of interest boundary selection image) with the actual sample. In some embodiments, processing circuitry 53, or 33 may apply a filter to the sample image by the analysis device so that the region of interest boundary indicator is projected onto the sample. In some embodiments, processing circuitry 53 of analysis device(s) 5, may project an image overlay (augmented reality) over the sample to guide a technician in aligning the sample with region of interest selection. In some embodiments, processing circuitry 53 may help the technician orient the sample to align with the region of interest images.

In some embodiments, the analysis device may include an imaging program for aligning the sample with the region of interest selection. In some embodiments, analysis device is aligned using just the region of interest boundary selection. In some embodiments, analysis device is aligned using a combination of the region of interest boundary selection and sample boundary selection. In some embodiments, analysis device is aligned using a combination of the region of interest boundary selection, sample boundary selection and sample scale selection. In some embodiments, analysis device is aligned using a combination of the region of interest boundary selection, sample boundary selection, sample scale selection, and user input data. In some embodiments, analysis device is aligned using a combination of the region of interest boundary selection, sample boundary selection, sample scale selection, user input data and augmented reality overlay.

In some embodiments, when the technician aligns the sample with the analysis device, processing circuitry 53 of analysis device(s) 5 may compare the sample to the first set of data items. In some embodiments, processing circuitry 53 may compare the sample to the first set of data items and identify a difference in alignment from the region of interest selection. The identification may comprises comparing the region of interest selection to a particular portion of the sample that corresponds to a region of interest. In some embodiments, processing circuitry 53 of analysis device(s) 5 may output a result of the comparison to a storage device (e.g., storage device 44, storage device 65, storage device 42, and/or storage device 50).

In some embodiments, processing circuitry 53 may transmit, as part of outputting the result a visual representation of the sample and the region of interest selection alignment. to clarify, the user selects a region of interest on a sample image, the technician selections a region of interest on the sample. When the processing circuitry 53 or 33 determines that the user selected region of interest on a sample image is aligned with the technician's selection of a region of interest on the sample an alert may sound from the analysis device or processing circuitry 53 or 33.

### Common Alignment Reference

As described herein, alignment of the selected region of interest site with the sample comprises alignment with a common alignment reference. In some embodiments, the common alignment reference comprises, consists, or consists essentially of an alignment truth that utilizes one or more of: sample scale, H&E image(s), a relative angle of the region of interest site, a relative size of the region of interest site, a fiducial marker, image lighting characteristics, a relative orientation of the region of interest site, or a relative location of the region of interest site to identify and implement the alignment truth to, for example, align the sample with the sample images. In an illustrative example, processing circuitry 23, 33, 43 or 53 may align a plurality of images from a first set of images with the common alignment truth.

In embodiments, the common alignment reference is a fiducial marker. In embodiments, imaging is performed using one or more fiducial markers, i.e., objects placed in the field of view of an imaging system that appear in the image produced. Fiducial markers can include, but are not limited to, detectable labels such as fluorescent, radioactive, chemiluminescent, calorimetric, and colorimetric labels. The use of fiducial markers to stabilize and orient biological samples is described, for example, in Carter et al., Applied Optics 46:421-427, 2007), the entire contents of which are incorporated herein by reference. In embodiments, the common alignment reference is a plurality of fiducial markers. In embodiments, the fiducial markers include titanium, chromium, platinum, tantalum, gold, a combination thereof, and/or an alloy thereof. In some embodiments, the fiducial markers have a thickness (e.g., vertical thickness, vertical deposition thickness) of between 10 nm and 50 nm. In embodiments, the fiducial markers have a thickness of between 40 nm and 300 nm. In embodiments, the alignment includes a similarity transform that comprises rotation, translation, and isotropic scaling of the fiducial markers of the image to minimize a residual error between the fiducial markers of the image and the corresponding fiducial markers in another image. In some embodiments, the transformation includes a perspective transform. In embodiments, a map of analyte data (e.g., a presence and/or an amount of analytes) can be aligned to an image of a sample using one or more fiducial markers.

### Detection Step

A backend system may or may not include an analysis device as part of the backend system. In some embodiments, the analysis device is a nucleic acid sequencing device. In embodiments, the analysis device is a fluorescent microscope. In embodiments, the analysis device is configured to detect fluorescently labeled probes. In embodiments, the analysis device is configured to detect fluorescently labeled nucleotides.

In embodiments, in addition to brightfield imaging or instead of brightfield imaging, fluorescence imaging is used to acquire one or more spatial images of the sample. As used herein the term “fluorescence imaging” refers to imaging that relies on the excitation and re-emission of light by fluorophores, regardless of whether the fluorophores are added experimentally to the sample and bound to antibodies (or other compounds) or simply natural features of the sample. In embodiments, each respective image in a single spatial projection (e.g., of a biological sample) represents a different channel in a plurality of channels, where each such channel in the plurality of channels represent an independent (e.g., different) wavelength or a different wavelength range (e.g., corresponding to a different emission wavelength). In embodiments, the images of a single spatial projection will have been taken of a tissue (e.g., the same tissue section) by a microscope at multiple wavelengths, where each such wavelength corresponds to the excitation frequency of a different kind of substance (containing a fluorophore) within or spatially associated with the sample. This substance can be a natural feature of the sample (e.g., a type of molecule that is naturally within the sample), or one that has been added to the sample. One manner in which such substances are added to the sample is in the form of probes that excite at specific wavelengths. Such probes can be directly added to the sample, or they can be conjugated to antibodies that are specific for some sort of antigen occurring within the sample, such as one that is exhibited by a particular protein. In this way, a user can use the spatial projection, comprising a plurality of such images to be able to see data mapped to (e.g., on top of) fluorescence image data, and to look at the relation between gene (or antibody) expression against another cellular marker, such as the spatial abundance of a particular protein that exhibits a particular antigen. In some embodiments, a biological sample is exposed to several different primary antibodies (or other forms of probes) in order to quantify several different proteins in a biological sample. In some such embodiments, each such respective different primary antibody (or probe) is then visualized with a corresponding secondary antibody type that is specific for one of the types of primary antibodies. Each such corresponding secondary antibody type is labeled with a different fluorescence label (different channel) that fluoresces at a unique wavelength or wavelength range (relative to the other fluorescence labels used). In this way, several different proteins in the biological sample can be visualized.

In embodiments, images in the set of images are acquired by exciting a target sample using a different wavelength or a different wavelength ranges. In embodiments, an image is acquired using transmission light microscopy (e.g., bright field transmission light microscopy, dark field transmission light microscopy, oblique illumination transmission light microscopy, dispersion staining transmission light microscopy, phase contrast transmission light microscopy, differential interference contrast transmission light microscopy, emission imaging, etc.). See, for example, Methods in Molecular Biology, 2018, Light Microscopy Method and Protocols, Markaki and Harz eds., Humana Press, New York, N.Y., ISBN-13: 978-1493983056, which is hereby incorporated by reference.

In embodiments, some or all of the sample analysis is performed on a device configured to perform sequence analysis. In some embodiments, the device is a benchtop sequencing platform. In some embodiments, the device delivers wide range of genomic applications. In some embodiments, the device provides real-time analysis metrics provided per lane and flow cell. In some embodiments, the device is configured to output demultiplexed FASTQ file. In some embodiments, the device is configured to output demultiplexed FASTQ file for seamless integration with bioinformatics pipelines. In some embodiments, the device is connected to the cloud for cloud-based storage and remote customer service.

In some embodiments, the portion of the sample that corresponds to the region of interest selection in the sample image is analyzed. In some embodiments, the portion of the sample is smaller than, larger than or the same size as the region of interest selection. In some embodiments, the entire sample is analyzed.

### Outputting Step

In the cloud-based implementations, the visual display device may receive various types of post-analysis data from the backend system, and present the data to the user, either in as-received form, or after performing some additional processing or formatting of the data by the analysis device processing circuitry 53 or other processing circuitry 43 or 33.

In some embodiments, the analysis device(s) outputs the post-processing report of the sample analysis which is based in part on the user identified region of interest selection session data (including the region of interest selection session). In some embodiments, the analysis device(s) outputs the post-processing report based on the first set of data items and second set of data items. In some embodiments, the analysis device(s) outputs the post-processing report of just the first set of data items or just the second set of data items.

In some embodiments, the processing circuitry 53, 43, 33 and/or 23 conducts a check or a combination of checks on the analysis result. If such check reveals an abnormal sequencing result (or abnormal outside an acceptable margin of normal), the processing circuitry 53, 43, 33 and/or 23 sends an alert to the visual display device to prompt the user. In some embodiments, the prompt may indicate a that the sample needs to be re-run. In some embodiments, the prompt may indicate a that the sample has a genetic defect. In some embodiments, the prompt may include a recommendation or instruction to contact the clinician, or the technician.

In some embodiments, the system enables bidirectional communication, e.g. to loop in the user, technician with various messages, such as “call the office,” etc.

### Reports

In some embodiments, visual display device 2 may at the completion of the region of interest selection session generate and/or export a report corresponding to the entire region of interest selection session or for individual sub-sessions. In some embodiments, processing circuitry, e.g., processing circuitry 23 of visual display device(s) 2, processing circuitry 33 of edge device(s) 3, processing circuitry 43 of webserver(s) 4, or processing circuitry 53 of analysis device(s) 5, may identify that the region of interest selection session is complete and provide a notification to the user that the region of interest selection session is complete, such as by providing a confirmation receipt or by marking tiles of a UI 44 or 24 interface as having a threshold number of sub-sessions complete. In some embodiments, processing circuitry 23, 33, or 43 may output a result of the region of interest selection session for display (via a display of visual display device(s) 2.

In some embodiments, visual display device 2 may detect receipt of a detection result (e.g., a target molecule is detected) from an analysis device and may generate and/or export a report corresponding to the detection data of the sample based at least in part on the user identified region of interest selection session data. In some embodiments, the result is a sequencing read. In embodiments, the result is a confirmation a target molecule is detected. In some embodiments, visual display device 2 may generate historical reports that include an aggregation of any one or more of the reports described above. In some embodiments, visual display device(s) 2 may receive a post-processing report, via network 10, such that the user may review the historical record and/or a summary of the historical record for a patient sample or same tissue sample type.

In some embodiments, processing circuitry, e.g., processing circuitry 23 of visual display device(s) 2, processing circuitry 33 of edge device(s) 3, processing circuitry 43 of webserver(s) 4, or processing circuitry 53 of analysis device(s) 5, may output the post-processing report by outputting the post-processing report from an analysis device via network 10 (e.g., via a bidirectional communication protocol). In some embodiments, processing circuitry 23 may output, via network 10, the post-processing report to another device of the user.

In some embodiments, the backend system may transmit a report back to the visual display device(s) 2 indicating a result of the sample analysis performed by the analysis device. In some embodiments, the summary report comprises, consists, or consists essentially of the one or more frames of the sample image and/or region of interest selection. In some embodiments, processing circuitry 23, 33, or 43 may generate a summary report (e.g., a post-processing report) including the one or more frames of the sample image, region of interest selection, sample boundary or scale selection. In some embodiments, the report would indicate if the user selected a region of interest on a sample image and whether the sample was aligned with the user's selection or not. The image can be obtained in any electronic image file format, including but not limited to JPEG/JFIF, TIFF, Exif, PDF, EPS, GIF, BMP, PNG, PPM, PGM, PBM, PNM, WebP, HDR raster formats, HEIF, BAT, BPG, DEEP, DRW, ECW, FITS, FLIF, ICO, ILBM, IMG, PAM, PCX, PGF, JPEG XR, Layered Image File Format, PLBM, SGI, SID, CD5, CPT, PSD, PSP, XCF, PDN, CGM, SVG, PostScript, PCT, WMF, EMF, SWF, XAML, and/or RAW. In embodiments, the image is obtained in any electronic color mode, including but not limited to grayscale, bitmap, indexed, RGB, CMYK, HSV, lab color, duotone, and/or multichannel.

In embodiments, a respective image includes a plurality of pixels. In embodiments, the plurality of pixels comprises at least 100, at least 500, at least 1000, at least 5000, at least 10,000, at least 50,000, at least 100,000, at least 500,000, at least 1×106, at least 2×10⁶, at least 3×10⁶, at least 5×10⁶, at least 8×10⁶, at least 1×10⁷, at least 1×10⁸, at least 1×10⁹, at least 1×10¹⁰, or at least 1×10¹¹ pixels. In some embodiments, the plurality of pixels comprises no more than 1×10¹², no more than 1×10¹¹, no more than 1×10¹⁰, no more than 1×10⁹, no more than 1×10⁸, no more than 1×10⁷, no more than 1×10⁶, no more than 100,000, no more than 10,000, or no more than 1000 pixels. In some embodiments, the plurality of pixels comprises from 1000 to 100,000, from 10,000 to 500,000, from 100,000 to 1×10⁶, from 500,000 to 1×10⁹, or from 1×10⁶ to 1×10⁸ pixels. In some embodiments, the plurality of pixels falls within another range starting no lower than 100 pixels and ending no higher than 1×10¹² pixels.

In embodiments, the report includes information obtained from the region of interest. In embodiments, the report includes the quantity of transcripts per area, the quantity of transcripts per cell, the quantity of genes per cell, percentage of transcripts belonging to cells, clustering metrics (e.g., a UMAP), cell segmentation information, proteins detected. In embodiments, the information is overlaid over the region of interest. In embodiments, the report are configured to read from and write to files generated by a spatial analyte analysis and/or image analysis workflow. The files can be configured to include tiled and untiled versions of images and analyte data, including but not limited to, gene expression data, alignment data, and gene expression-based clustering information. The gene expression-based clustering information can include t-Distributed Stochastic Neighbor Embedding (t-SNE) and Uniform Manifold Approximation and Projection (UMAP) projections.

An example of a file type is the VCF (SNP) file type. VCF stands for “Variant Call Format.” It is a standardized text file format for representing SNP, INDEL, SV, and CNV variation calls. SNPs (Single Nucleotide Polymorphisms) are the most common type of genetic variation among the genomes of people. Each SNP represents a difference in a single DNA building block (e.g., nucleotide). In practice, this is a widely used VCF. Another example of a file type is the VCF (INDEL) file type. Indel is a molecular biology term for insertions or deletions in DNA. The number of INDELs in human genomes is second only to the number of SNPs. INDELs can play a key role in genetics. Another example is the VCF (SV) file type. SVs (or Structural Variants) are large DNA sequences that are inserted, inverted, deleted or duplicated within genomes. Another example is the VCF (CNV) file type. A CNV (or Copy Number Variation) is when the number of copies of a particular gene varies from one individual to the next. Some cancers are believed to be associated with elevated copy number of particular genes. Another example is the BAM file type. The Binary Alignment Map (BAM) can be the comprehensive raw data of genomic sequencing; it can include the lossless, compressed binary representation of the sequence alignment map. BAM files tend to be about 90-100 gigabytes in size. They can be generated by aligning the FASQ files to the reference genome. A BAM file (.bam) is the binary version of a SAM file. A SAM file (.sam) is a tab-delimited text file that contains sequence alignment data. Another example is the FASTQ file type. FASTQ files contain billions of entries and are about 90-100 gigabytes in size, making them too large to open in a normal text editor. FASTQ files can be the ultimate raw data. Another file type is a quality control metric file type (e.g., report). Before running any alignment or assembly, it is possible to check the quality of the underlying data. Quality can be checked from within a sequencing program. A quality control analysis can test a number of different metrics and produce a consolidated report. The report can include a simple categorization (e.g., red, yellow, green) to indicate whether results are bad, intermediate, or good.

In embodiments, the report includes an image. The image is in any file format including but not limited to JPEG/JFIF, TIFF, Exif, PDF, EPS, GIF, BMP, PNG, PPM, PGM, PBM, PNM, WebP, HDR raster formats, HEIF, BAT, BPG, DEEP, DRW, ECW, FITS, FLIF, ICO, ILBM, IMG, PAM, PCX, PGF, JPEG XR, Layered Image File Format, PLBM, SGI, SID, CDS, CPT, PSD, PSP, XCF, PDN, CGM, SVG, PostScript, PCT, WMF, EMF, SWF, XAML, and/or RAW. In embodiments, the image is represented as an array (e.g., matrix) comprising a plurality of pixels, such that the location of each respective pixel in the plurality of pixels in the array (e.g., matrix) corresponds to its original location in the image. In some embodiments, an image is represented as a vector comprising a plurality of pixels, such that each respective pixel in the plurality of pixels in the vector comprises spatial information corresponding to its original location in the image. In embodiments, a pixel includes one or more pixel values (e.g., intensity value). In embodiments, each respective pixel in the plurality of pixels includes one pixel intensity value, such that the plurality of pixels represents a single-channel image comprising a one-dimensional integer vector comprising the respective pixel values for each respective pixel. For example, an 8-bit single-channel image (e.g., grey-scale) can include 28 or 256 different pixel values (e.g., 0-255). In embodiments, each respective pixel in the plurality of pixels of an image includes a plurality of pixel values, such that the plurality of pixels represents a multi-channel image comprising a multi-dimensional integer vector, where each vector element represents a plurality of pixel values for each respective pixel. For example, a 24-bit 3 -channel image (e.g., RGB color) can include 224 (e.g., 28×3) different pixel values, where each vector element comprises 3 components, each between 0-255. In some embodiments, an n-bit image includes up to 2ⁿ different pixel values, where n is any positive integer.

### Artificial Intelligence (AI) Engines And/or Machine Learning (ML) Models

The methods and tools disclosed herein may, in some embodiments, use artificial intelligence (AI) engines and/or machine learning (ML) models. A trained ML model 46, 36, 26 and/or AI engine 45, 35, 25 are configured to process and analyze the user input (e.g., images of the region of interest site, region of interest boundary selection, sample boundary selection, sample scale selection, user input data, etc.), where ML models are considered advantageous (e.g., predictive modeling, inference detection, contextual matching, natural language processing, etc.). Examples of ML models and/or AI engines that are so configured to perform aspects of this disclosure include classifiers and non-classification ML models, artificial neural networks (“NNs”), linear regression models, logistic regression models, decision trees, support vector machines (“SVM”), Naïve or a non-Naïve Bayes network, k-nearest neighbors (“KNN”) models, deep learning (DL) models, k-means models, clustering models, random forest models, or any combination thereof. Depending on the implementation, the ML models are supervised, unsupervised or in some embodiments, a hybrid combination (e.g., semi-supervised). These models are trained based on data indicating how users (e.g., user 4) interact with visual display device(s) 2. For example, certain aspects of the disclosure will be described using events or behaviors (such as clicking, viewing, or watching) with respect to items (e.g., sample images, images of the region of interest site, region of interest boundary selection, sample boundary selection, sample scale selection, user input data, cameras, etc.), for purposes of illustration only. In some embodiments, these models and engines are trained to synthesize data in order to identify region of interest boundary site(s) of the sample, sample boundary sites, scale selection, and/or user input data.

In addition, the ML models are trained using region of interest boundary selection data, sample boundary selection data, sample scale data, and/or user input data to evaluate patient samples. In some embodiments, the tools of this disclosure may invoke image recognition or image processing AI that leverages (e.g., is trained using) region of interest boundary selection data, sample boundary selection data, sample scale data, and/or user input data available from various sources. In some embodiments, the tools of this disclosure may store session information (e.g., sub-session information, combined session information, etc.) and results of previous sessions (e.g., locally at the visual display device, to a cloud storage resource, or to both). The visual display device may do this in order to assist the user and/or the analysis device in tracking regions of interest boundaries and sample boundaries with respect to typical regions of interest or typical sample boundaries for purposes of building an AI tool.

The methods and tools disclosed herein may, in some embodiments, use classification AI to classify normal samples vs samples with an underlying disease, diagnosis, or prognosis.

In some embodiments, user 4 may exhibit difficulty with capturing images or identifying the region of interest site/boundary or selecting the sample scale or completing/selecting user input data. This helpful data is shared across a computing network so that optimal results are presented to more than one user based on similar queries and user reactions to those queries. In some embodiments, engine(s) 45, 35, 25 and/or ML model(s) 46, 36, 26 may utilize a deep-neural network to localize a region of interest site in a sample image and classify the sample. In some embodiments, AI engine(s) 45, 35, 25 and/or ML model(s) 46, 36, 26 may utilize Naïve Bayes and/or decision trees to synthesize (e.g., combine) first set of data items and second set of data items and the analysis thereof (e.g., image analysis and sequencing analysis) in order to obtain a comprehensive sequence determination for user 4 and include such comprehensive determinations in a post-processing report.

In some embodiments, AI engine(s) 45, 35, 25 and/or ML model(s) 46, 36, 26 are loaded with and trained on cohort parameters (e.g., age cohorts, region of interest cohorts, sample boundary cohorts, indication cohorts, etc.) and combinations of cohort parameters. In some embodiments, AI engine(s) 45, 35, 25 and/or ML model(s) 46, 36, 26 may utilize historical reference interrogations for comparison when determining deviations from baseline parameters.

In addition, visual display device(s) 2, edge device(s) 3, server(s) 4, may utilize different image processing algorithms and/or data synthesis algorithms, such as AI, ML, DL, digital signal processing, neural networks, and/or other techniques, depending on various different contexts.

In addition, trained AI engine(s) 45, 35, 25 are used to learn about region of interest sites, sample boundaries, sample scales and user input data over time. In this way, AI engine(s) 45, 35, 25 may provide a detection algorithm for identifying region of interest sites, sample boundaries, sample scales and user input data. In some embodiments, AI engine(s) 45, 35, 25 are loaded with and trained on cohort parameters, using historical reference interrogations or images for comparison. In this way, visual display device(s) 2 may provide a solution using different algorithm approaches (e.g., AI, ML, DL, digital signal processing, neural networks, and/or other techniques) in order to better characterize a sample, region of interest sites, sample boundaries, sample scales and user input data.

In some embodiments, AI engine(s) 45, 35, 25 and/or ML models(s) 46, 36, 26 are trained on several images that have been labeled as corresponding to a tumor, fibroid, nodule, or not.

### Alerts

In some embodiments, processing circuitry of system 100, provide an alert to user 4. The alert is an audible alert, a visual alert generated by visual display device(s) 2, such as a text prompt or flashing buttons or screen, or a tactile alert generated by the analysis device(s) 5 and/or visual display device(s) 2 or other devices, e.g., via network 10, such as a vibration or vibrational pattern. Furthermore, the alert is provided to other devices, e.g., via network 10. Several different levels of alerts are used based on the importance of the alert (high, medium, low).

In further examples, visual display device 2 may generate an alert to user 4 (or relay an alert from an analysis device(s) 5, edge device(s) 3, or webserver(s) 4) based on a sequence information from a combination of data items, which may enable user 4 proactively to escalate a sample or escalate instructing a patient treatment to seek medical intervention.

### Authentication

In some instances, the processing circuitry system may implement the region of interest selection session in a secure setting, such as on an authenticated visual display device and/or over a secure data network. In some embodiments, processing circuitry, e.g., processing circuitry 23 of visual display device(s) 2, processing circuitry 33 of edge device(s) 3, processing circuitry 43 of webserver(s) 4, or processing circuitry 53 of analysis device(s) 5, may authenticate the user. In some embodiments, the user will enter authentication data, or identification data in order to enter the region of interest selection session.

### Augmented Reality Overlays

Additional examples disclosed herein also represent improvements in computer-related technology. For example, the camera system may use augmented overlays in order to allow a user to accurately align a region of interest site, sample boundary or image scale or other part of the sample, such that images are obtained in a consistent and reliable manner. Another technical improvement comprises, consists, or consists essentially of the use of multiple images of the sample/region of interest boundary selection, sample boundary selection or scale selection in order to develop a combined selection which is based on more than one region of interest boundary selection, sample boundary selection or scale selection. In such situations the processing circuitry 23, 33 or 43 determines the region of interest site based on more than one region of interest boundary selection, sample boundary selection or scale selection. The region of interest boundary selection, sample boundary selection or scale selection comprises, consists, or consists essentially of an augmented reality overlay over the sample image, such that a technician is able to accurately align the selected region of interest site, selected boundary and/or selected scale with the sample when processing the sample for analysis e.g. by the analysis device. In embodiments, the visualization tools are configured to provide a user input system and user interface, such as a desktop application that provides interactive visualization functionality to perform any of the workflows or processes described herein. In some embodiments, the visualization tools include a browser that can be configured to enable users to evaluate and interact with different views of the spatial analyte data to quickly gain insights into the underlying biology of the samples being analyzed. The browser can be configured to evaluate analytes (e.g., genes), characterize and refine clusters of data, and to perform differential analysis (e.g., expression analysis) within the spatial context of an image and/or a spatial dataset. In embodiments, the browser is capable of converting electronic content into a user-comprehensible format (e.g., visual, aural, graphical, etc.). For instance, the user device may execute a web browser application which provides a browser window on a display of the user device. The web browser application that provides the browser window may operate by receiving input of a uniform resource locator (URL), such as a web address, from an input device (e.g., a pointing device, a keyboard, a touch screen, or another form of input device) or from a memory element.

### Bidirectional

While described from the perspective of a user visual display device 2 performing the techniques of this disclosure, it should be noted that the system of this disclosure supports bidirectional communication between a user (e.g., user 4) and an analysis device.

The disclosure is further understood by the following numbered paragraphs:
P1. A method of processing a sample for analysis, the method comprising: providing a region of interest selection session configured to allow a user to navigate a plurality of sub-sessions comprising at least a first image processing sub-session and a second data processing sub-session distinct from the first image processing sub-session; capturing a sample image; capturing a region of interest selection within the sample image in the first image processing sub-session; capturing a second set of data items in accordance with the second data processing sub-session of the region of interest selection session, the second set of data items distinct from the sample image and comprising one or more of: data obtained from the user or user-input data.
P2. The method of P1 wherein providing is performed by a webserver, an edge device, a visual display device or combinations thereof.
P3. The method of P1 wherein capturing is performed by a webserver, an edge device, a visual display device or combinations thereof.
P4. The method of any of P1 to P3, wherein the first image processing sub-session comprises, consists, or consists essentially of capturing the sample image via one or more cameras or downloading an image.
P5 The method of any of P1 to P4 wherein the first image processing sub-session comprises, consists, or consists essentially of capturing the region of interest boundary selection, sample boundary selection, sample scale selection and combinations thereof.
P6 The method of any of P1 to P5 wherein the second data processing sub-session comprises, consists, or consists essentially of capturing user-input data.
P7 The method of any of P1 to P6, further comprising transferring data from the first image processing sub-session and/or second data processing sub-session to an analysis device or technician.
P8 The method of any of P1 to P7, further comprising extracting at least a portion of the region of interest from the sample based at least in part on the data from the first image processing sub-session and/or second data processing sub-session.
P9 The method of any of P1 to P8, further comprising analyzing at least a portion of the sample that corresponds to at least part of the data from the first image processing sub-session and/or second data processing sub-session.
P10 The method of any of P1 to P9, further comprising outputting a report based at least in part on the data from the first image processing sub-session and/or second data processing sub-session.
P11 The method of any of P1 to P10, wherein the sample image comprises, consists, or consists essentially of one or more frames that represent the sample.
P12 The method of any of P1 to P11, wherein the region of interest boundary selection comprises, consists, or consists essentially of one or more region of interest boundary selections on one or more sample image.
P13 The method of any of P1 to P12, wherein the sample boundary selection comprises, consists, or consists essentially of one or more sample boundary selections on one or more sample image.
P14 The method of any of P1 to P13, wherein the sample scale selection comprises, consists, or consists essentially of one or more sample scale selections on one or more sample image.
P15 The method of any of P1 to P14, wherein providing the region of interest selection session comprises, consists, or consists essentially of: providing a top-level interface that comprises, consists, or consists essentially of a first interface tile, wherein the first interface tile corresponds to the first image processing sub-session, and wherein the first image processing sub-session comprises, consists, or consists essentially of a first image processing sub-session interface level that is at a same level relative to a level of the top-level interface.
P16 The method of any of P1 to P15, wherein providing the region of interest selection session comprises, consists, or consists essentially of: providing a top-level interface that comprises, consists, or consists essentially of a second interface tile, wherein the second interface tile corresponds to the second data processing sub-session, and wherein the second data processing sub-session comprises, consists, or consists essentially of a second data processing sub-session interface level that is at a same level relative to a level of the top-level interface.
P17 The method of any of P1 to P16, wherein the region of interest boundary selection, sample boundary selection and/or sample scale selection comprises, consists, or consists essentially of an image overlay.
P18 The method of P17 wherein the image overlay is a predefined size or shape.
P19 The method of P17 wherein the image overlay is not a predefined size or shape.
P20 The method of any of P1 to P19, wherein providing the first image processing sub-session comprises, consists, or consists essentially of: detecting selection of the first interface tile; and providing the first image processing sub-session of the region of interest selection session.
P21 The method of any of P1 to P20, wherein providing the second data image processing sub-session comprises, consists, or consists essentially of: detecting selection of the second interface tile; and providing the second data processing sub-session of the region of interest selection session.
P22 The method of P15 or P16 wherein the top-level interface comprises, consists, or consists essentially of the first interface tile and the second interface tile.
P23 The method of P23 further comprising providing the first image processing sub-session of the region of interest selection session; modifying the first interface tile to indicate completion of the first image processing sub-session; providing, subsequent to the first data processing sub-session, the second data processing sub-session of the region of interest selection session; modifying the second interface tile to indicate completion of the second data processing sub-session.
P24 The method of any of P1 to P23, wherein the second data processing sub-session is initiated subsequent to the completion of the first image processing sub-session.
P24 The method of any of P1 to P24, wherein the second data processing sub-session is initiated before the completion of the first image processing sub-session.
P26 The method of any of P1 to P25, wherein the first image processing sub-session is initiated subsequent to the completion of the second data processing sub-session.
P27 The method of P7, wherein transferring data from the first image processing sub-session and/or second data processing sub-session to an analysis device or technician comprises, consists, or consists essentially of transferring at least one of the first set of data items or the second set of data items.
P28 The method of any of P1 to P27, wherein capturing a sample image is performed by camera on a visual display device.
P29 The method of any of P1 to P28, wherein providing the region of interest selection session is performed by a visual display device, a webserver, edge devices or combinations thereof.
P30 A system for processing a sample comprising one or more systems for performing the methods of any of P1-P29.

In some implementations, the above-described paragraphs can be implemented using an apparatus comprising one or more means for performing some or all of the various operations.
R1 A system for processing a sample for analysis, the system comprising a memory configured to store a sample image; one or more processors implemented in circuitry and configured to: provide a region of interest selection session configured to allow a user to navigate a plurality of sub-sessions comprising at least a first image processing sub-session and a second data processing sub-session distinct from the first image processing sub-session.
R2 The system of R1 wherein the memory is on a webserver, an edge device, a visual display device or combinations thereof.
R3 The system of R1 wherein the one or more processors is on a webserver, an edge device, a visual display device or combinations thereof.
R4 The system of any of R1 to R3 wherein the one or more processors are further configured to capturing the sample image via one or more cameras or downloading an image.
R5 The system of any of R1 to R4 wherein the one or more processors are further configured to capture the region of interest boundary selection, sample boundary selection, sample scale selection and combinations thereof.
R6 The system of any of R1 to R5 wherein the one or more processors are further configured to capture user-input data.
R7 The system of any of R1 to R6 wherein the one or more processors are further configured to transfer data from the first image processing sub-session and/or second data processing sub-session to an analysis device or technician.
R8 The system of any of R1 to R7 wherein extracting at least a portion of the region of interest from the sample based at least in part on the data from the first image processing sub-session and/or second data processing sub-session.
R9 The system of any of R1 to R8 wherein the one or more processors are further configured to analyze the sample based at least in part on the data from the first image processing sub-session and/or second data processing sub-session.
R10 The system of any of R1 to R9 wherein the one or more processors are further configured to output a report based at least in part on the data from the first image processing sub-session and/or second data processing sub-session.
R11 The system of any of R1 to R10 wherein the one or more processors are further configured to capture one or more frames that represent the sample.
R12 The system of any of R1 to R11 wherein the one or more processors are further configured to capture one or more region of interest boundary selections on one or more sample image.
R13 The system of any of R1 to R12 wherein the one or more processors are further configured to capture one or more sample boundary selections on one or more sample image.
R14 The system of any of R1 to R13 wherein the one or more processors are further configured to capture one or more sample scale selections on one or more sample image.
R15 The system of any of R1 to R14 wherein the one or more processors are further configured to provide a top-level interface that comprises, consists, or consists essentially of a first interface tile, wherein the first interface tile corresponds to the first image processing sub-session, and wherein the first image processing sub-session comprises, consists, or consists essentially of a first image processing sub-session interface level that is at a same level relative to a level of the top-level interface.
R16 The system of any of R1 to R15 wherein the one or more processors are further configured to provide the region of interest selection session comprises, consists, or consists essentially of: providing a top-level interface that comprises, consists, or consists essentially of a second interface tile, wherein the second interface tile corresponds to the second data processing sub-session, and wherein the second data processing sub-session comprises, consists, or consists essentially of a second data processing sub-session interface level that is at a same level relative to a level of the top-level interface.
R17 The system of any of R1 to R16 wherein the one or more processors are further configured to provide an image overlay.
R18 The system of R17 wherein the one or more processors are further configured to provide an image overlay of a predefined size or shape.
R19 The system of R17 wherein the one or more processors are further configured to provide an image overlay that is not a predefined size or shape.
R20 The system of any of R1 to R19 wherein the one or more processors are further configured to provide the first image processing sub-session which comprises, consists, or consists essentially of: detecting selection of the first interface tile; and providing the first image processing sub-session of the region of interest selection session.
R21 The system of any of R1 to R20 wherein the one or more processors are further configured to provide the second data image processing sub-session which comprises, consists, or consists essentially of: detecting selection of the second interface tile; and providing the second data processing sub-session of the region of interest selection session.
R22 The system of R15 or R16 wherein the top-level interface comprises, consists, or consists essentially of the first interface tile and the second interface tile.
R23 The system of R22 wherein the one or more processors are further configured to provide the first image processing sub-session of the region of interest selection session; modifying the first interface tile to indicate completion of the first image processing sub-session; providing, subsequent to the first data processing sub-session, the second data processing sub-session of the region of interest selection session; modifying the second interface tile to indicate completion of the second data processing sub-session.
R24 The system of any of R1 to R23 wherein the one or more processors are further configured to provide the second data processing sub-session that is initiated subsequent to the completion of the first image processing sub-session.
R25 The system of any of R1 to R24 wherein the one or more processors are further configured to provide the second data processing sub-session that is initiated before the completion of the first image processing sub-session.
R26 The system of any of R1 to R25 wherein the one or more processors are further configured to provide the first image processing sub-session that is initiated subsequent to the completion of the second data processing sub-session.
R27 The system of R7 wherein the one or more processors are further configured to transfer data from the first image processing sub-session and/or second data processing sub-session to an analysis device or technician comprises, consists, or consists essentially of transferring at least one of the first set of data items or the second set of data items.
R28 The system of any of R1 to R27 wherein the one or more processors are further configured to capture a sample image by a camera on a visual display device.
R29 The system of any of R1 to R28 wherein providing the region of interest selection session is performed by a visual display device, a webserver, edge devices or combinations thereof.

In some implementations, the above-described paragraphs can be implemented using an apparatus comprising one or more means for performing some or all of the various operations.

### Apparatus

PP1 An apparatus for processing a sample that comprises, consists, or consists essentially of: a means for providing a region of interest selection session configured to allow a user to navigate a plurality of sub-sessions comprising at least a first image processing sub-session and a second data processing sub-session distinct from the first image processing sub-session; capturing a sample image; capturing a region of interest selection within the sample image in the first image processing sub-session; capturing a second set of data items in accordance with the second data processing sub-session of the region of interest selection session, the second set of data items distinct from the sample image and comprising one or more of: data obtained from the user or user-input data.
PP2 The apparatus of PP1 wherein providing is performed by a webserver, an edge device, a visual display device or combinations thereof.
PP3 The apparatus of PP1 wherein capturing is performed by a webserver, an edge device, a visual display device or combinations thereof.
PP4 The apparatus of any of PP1 to PP3 wherein the first image processing sub-session comprises, consists, or consists essentially of a means for capturing the sample image via one or more cameras or downloading an image.
PP5 The apparatus of any of PP1 to PP4, wherein the first image processing sub-session comprises, consists, or consists essentially of a means for capturing the region of interest boundary selection, sample boundary selection, sample scale selection and combinations thereof.
PP6 The apparatus of any of PP1 to PP5, wherein the second data processing sub-session comprises, consists, or consists essentially of a means for capturing user-input data.
PP7 The apparatus of any of PP1 to PP6, further comprising a means for transferring data from the first image processing sub-session and/or second data processing sub-session to an analysis device or technician.
PP8 The apparatus of any of PP1 to PP7, further comprising a means for extracting at least a portion of the region of interest from the sample based at least in part on the data from the first image processing sub-session and/or second data processing sub-session.
PP9 The apparatus of any of PP1 to PP8, further comprising a means for analyzing at least a portion of the sample that corresponds, at least in part, on the data from the first image processing sub-session and/or second data processing sub-session.
PP10 The apparatus of any of PP1 to PP9, further comprising a means for outputting a report based at least in part on the data from the first image processing sub-session and/or second data processing sub-session.
PP11 The apparatus of any of PP1 to PP10, wherein the sample image comprises, consists, or consists essentially of one or more frames that represent the sample.
PP12 The apparatus of any of PP1 to PP11, wherein the region of interest boundary selection comprises, consists, or consists essentially of one or more region of interest boundary selections on one or more sample image.
PP13 The apparatus of any of PP1 to PP12, wherein the sample boundary selection comprises, consists, or consists essentially of one or more sample boundary selections on one or more sample image.
PP14 The apparatus of any of PP1 to PP13, wherein the sample scale selection comprises, consists, or consists essentially of one or more sample scale selections on one or more sample image.
PP15 The apparatus of any of PP1 to PP14, wherein providing the region of interest selection session comprises, consists, or consists essentially of: providing a means for a top-level interface that comprises, consists, or consists essentially of a first interface tile, wherein the first interface tile corresponds to the first image processing sub-session, and wherein the first image processing sub-session comprises, consists, or consists essentially of a first image processing sub-session interface level that is at a same level relative to a level of the top-level interface.
PP16 The apparatus of any of PP1 to PP15, wherein providing the region of interest selection session comprises, consists, or consists essentially of: providing a means for a top-level interface that comprises, consists, or consists essentially of a second interface tile, wherein the second interface tile corresponds to the second data processing sub-session, and wherein the second data processing sub-session comprises, consists, or consists essentially of a second data processing sub-session interface level that is at a same level relative to a level of the top-level interface.
PP17 The apparatus of any of PP1 to PP16, wherein the region of interest boundary selection, sample boundary selection and/or sample scale selection comprises, consists, or consists essentially of providing a means for an image overlay.
PP18 The apparatus of PP17 wherein the image overlay is a predefined size or shape.
PP19 The apparatus of PP17 wherein the image overlay is not a predefined size or shape.
PP20 The apparatus of any of PP1 to PP19, wherein providing the first image processing sub-session comprises, consists, or consists essentially of providing a means for detecting selection of the first interface tile; and providing the first image processing sub-session of the region of interest selection session.
PP21 The apparatus of any of PP1 to PP20 wherein providing the second data image processing sub-session comprises, consists, or consists essentially of: providing a means for detecting selection of the second interface tile; and providing the second data processing sub-session of the region of interest selection session.
PP22 The apparatus of PP15 or PP16, wherein the top-level interface comprises, consists, or consists essentially of the first interface tile and the second interface tile.
PP23 The apparatus of PP22 further comprising providing the first image processing sub-session of the region of interest selection session; providing a means for modifying the first interface tile to indicate completion of the first image processing sub-session; providing, subsequent to the first data processing sub-session, the second data processing sub-session of the region of interest selection session; providing a means for modifying the second interface tile to indicate completion of the second data processing sub-session.
PP24 The apparatus of any of PP1 to PP23, wherein the second data processing sub-session is initiated subsequent to the completion of the first image processing sub-session.
PP25 The apparatus of any of PP1 to PP24, wherein the second data processing sub-session is initiated before the completion of the first image processing sub-session.
PP26 The apparatus of any of PP1 to PP25, wherein the first image processing sub-session is initiated subsequent to the completion of the second data processing sub-session.
PP27 The apparatus of PP7 wherein transferring data from the first image processing sub-session and/or second data processing sub-session to an analysis device or technician comprises, consists, or consists essentially of providing a means for transferring at least one of the first set of data items or the second set of data items.
PP28 The apparatus of any of PP1 to PP27, wherein capturing a sample image is performed by camera on a visual display device.
PP29 The apparatus of any of PP1 to PP28, wherein providing the region of interest selection session is performed by a visual display device, a webserver, edge devices or combinations thereof.
Q1 A non-transitory computer-readable storage medium having stored thereon instructions that, when executed, cause one or more processors to: provide a region of interest selection session to a user, the region of interest selection session configured to allow the user to navigate a plurality of sub-sessions comprising at least a first image processing sub-session and a second data processing sub-session distinct from the first image processing sub-session.
Q2 The non-transitory computer-readable storage medium of Q1, wherein providing is performed by a webserver, an edge device, a visual display device or combinations thereof.
Q3 The non-transitory computer-readable storage medium of Q1, wherein capturing is performed by a webserver, an edge device, a visual display device or combinations thereof.
Q4 The non-transitory computer-readable storage medium of any of Q1 to Q3 wherein the first image processing sub-session comprises, consists, or consists essentially of capturing the sample image via one or more cameras or downloading an image.
Q5 The non-transitory computer-readable storage medium of any of Q1 to Q4 wherein the first image processing sub-session comprises, consists, or consists essentially of capturing the region of interest boundary selection, sample boundary selection, sample scale selection and combinations thereof.
Q6 The non-transitory computer-readable storage medium of any of Q1 to Q5 wherein the second data processing sub-session comprises, consists, or consists essentially of capturing user-input data.
Q7 The non-transitory computer-readable storage medium of any of Q1 to Q6 further comprising transferring data from the first image processing sub-session and/or second data processing sub-session to an analysis device or technician.
Q8 The non-transitory computer-readable storage medium of any of Q1 to Q7 further comprising extracting at least a portion of the region of interest from the sample based at least in part on the data from the first image processing sub-session and/or second data processing sub-session.
Q9 The non-transitory computer-readable storage medium of any of Q1 to Q8, further comprising analyzing at least a portion of the sample that corresponds to, at least in part, data from the first image processing sub-session and/or second data processing sub-session.
Q10 The non-transitory computer-readable storage medium of any of Q1 to Q9, further comprising outputting a report based at least in part on the data from the first image processing sub-session and/or second data processing sub-session.
Q11 The non-transitory computer-readable storage medium of any of Q1 to Q10, wherein the sample image comprises, consists, or consists essentially of one or more frames that represent the sample.
Q12 The non-transitory computer-readable storage medium of any of Q1 to Q11, wherein the region of interest boundary selection comprises, consists, or consists essentially of one or more region of interest boundary selections on one or more sample image.
Q13 The non-transitory computer-readable storage medium of any of Q1 to Q12, wherein the sample boundary selection comprises, consists, or consists essentially of one or more sample boundary selections on one or more sample image.
Q14 The non-transitory computer-readable storage medium of any of Q1 to Q13, wherein the sample scale selection comprises, consists, or consists essentially of one or more sample scale selections on one or more sample image.
Q15 The non-transitory computer-readable storage medium of any of Q1 to Q14, wherein providing the region of interest selection session comprises, consists, or consists essentially of: providing a top-level interface that comprises, consists, or consists essentially of a first interface tile, wherein the first interface tile corresponds to the first image processing sub-session, and wherein the first image processing sub-session comprises, consists, or consists essentially of a first image processing sub-session interface level that is at a same level relative to a level of the top-level interface.
Q16 The non-transitory computer-readable storage medium of any of Q1 to Q15, wherein providing the region of interest selection session comprises, consists, or consists essentially of: providing a top-level interface that comprises, consists, or consists essentially of a second interface tile, wherein the second interface tile corresponds to the second data processing sub-session, and wherein the second data processing sub-session comprises, consists, or consists essentially of a second data processing sub-session interface level that is at a same level relative to a level of the top-level interface.
Q17 The non-transitory computer-readable storage medium of any of Q1 to Q17, wherein the region of interest boundary selection, sample boundary selection and/or sample scale selection comprises, consists, or consists essentially of an image overlay.
Q18 The non-transitory computer-readable storage medium of Q17 wherein the image overlay is a predefined size or shape.
Q19 The non-transitory computer-readable storage medium of Q17 wherein the image overlay is not a predefined size or shape.
Q20 The non-transitory computer-readable storage medium of any of Q1 to Q19, wherein providing the first image processing sub-session comprises, consists, or consists essentially of: detecting selection of the first interface tile; and providing the first image processing sub-session of the region of interest selection session.
Q21 The non-transitory computer-readable storage medium of any of Q1 to Q20, wherein providing the second data image processing sub-session comprises, consists, or consists essentially of: detecting selection of the second interface tile; and providing the second data processing sub-session of the region of interest selection session.
Q22 The non-transitory computer-readable storage medium of Q15 or Q16 wherein the top-level interface comprises, consists, or consists essentially of the first interface tile and the second interface tile.
Q23 The non-transitory computer-readable storage medium of Q22 further comprising providing the first image processing sub-session of the region of interest selection session; modifying the first interface tile to indicate completion of the first image processing sub-session; providing, subsequent to the first data processing sub-session, the second data processing sub-session of the region of interest selection session; modifying the second interface tile to indicate completion of the second data processing sub-session.
Q24 The non-transitory computer-readable storage medium of any of Q1 to Q23 wherein the second data processing sub-session is initiated subsequent to the completion of the first image processing sub-session.
Q25 The non-transitory computer-readable storage medium of any of Q1 to Q24 wherein the second data processing sub-session is initiated before the completion of the first image processing sub-session.
Q26 The non-transitory computer-readable storage medium of any of Q1 to Q25 wherein the first image processing sub-session is initiated subsequent to the completion of the second data processing sub-session.
Q27 The non-transitory computer-readable storage medium of Q7 wherein transferring data from the first image processing sub-session and/or second data processing sub-session to an analysis device or technician comprises, consists, or consists essentially of transferring at least one of the first set of data items or the second set of data items.
Q28 The non-transitory computer-readable storage medium of any of Q1 to Q27 wherein capturing a sample image is performed by camera on a visual display device.
Q29 The non-transitory computer-readable storage medium of any of Q1 to Q28 wherein providing the region of interest selection session is performed by a visual display device, a webserver, edge devices or combinations thereof.

Various examples have been described. However, one skilled in the art will appreciate that various modifications are made to the described examples without departing from the scope of the claims. It is to be recognized that depending on the example, certain acts or events of any of the techniques described herein can be performed in a different sequence, are added, merged, or left out altogether (e.g., not all described acts or events are necessary for the practice of the techniques). Moreover, in certain examples, acts or events are performed concurrently, e.g., through multi-threaded processing, interrupt processing, or multiple processors, rather than sequentially.

Based upon the above discussion and illustrations, it is recognized that various modifications and changes are made to the disclosed technology in a manner that does not necessarily require strict adherence to the examples and applications illustrated and described herein. Such modifications do not depart from the true spirit and scope of various aspects of the disclosure, including aspects set forth in the claims.

In one or more examples, the functions described are implemented in hardware, software, firmware, or any combination thereof. If implemented in software, the functions are stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media are any available media that can be accessed by one or more computers or one or more processors to retrieve instructions, code and/or data structures for implementation of the techniques described in this disclosure. A computer program product may include a computer-readable medium.

By way of example, and not limitation, such computer-readable data storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Combinations of the above should also be included within the scope of computer-readable media. The memory typically includes high-speed random access memory, such as DRAM, SRAM, DDR RAM, ROM, EEPROM, flash memory, CD-ROM, digital versatile disks (DVD) or other optical storage, magnetic cassettes, magnetic tape, magnetic disk storage or other magnetic storage devices, other random access solid state memory devices, or any other medium which can be used to store desired information; and optionally includes non-volatile memory, such as one or more magnetic disk storage devices, optical disk storage devices, flash memory devices, or other non-volatile solid state storage devices.

Instructions are executed by one or more processors, such as one or more DSPs, general purpose microprocessors, ASICs, FPGAs, CPLDs, or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

Any of the above-mentioned “processors,” and/or devices incorporating any of the above-mentioned processors or processing circuitry, may, in some embodiments, be referred to herein as, for example, “computers,” “computer devices,” “visual display devices,” “hardware visual display devices,” “hardware processors,” “processing units,” “processing circuitry,” etc. Visual display devices of the above examples may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In some embodiments, the visual display devices are controlled by a proprietary operating system. Conventional operating systems control and schedule computer processes for execution, perform memory management, provide file system, networking, I/O services, and provide UI functionality, such as GUI functionality, among other things.

The techniques of this disclosure are implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units.

Various examples have been described. These and other examples are within the scope of the following claims.

What is claimed is:

1. A method of processing a sample for analysis, the method comprising: providing a region of interest selection session configured to allow a user to navigate a plurality of sub-sessions comprising at least a first image processing sub-session and a second data processing sub-session distinct from the first image processing sub-session; capturing a sample image; capturing a region of interest selection within the sample image in the first image processing sub-session; capturing a second set of data items in accordance with the second data processing sub-session of the region of interest selection session, the second set of data items distinct from the sample image and comprising one or more of: data obtained from the user or user-input data.

2. The method of claim 1, wherein the first image processing sub-session comprises, consists, or consists essentially of an initial sub-session, the initial sub-session comprising, consisting, or consisting essentially of capturing the sample image via one or more cameras or downloading an image.

3. The method of claim 1, wherein the first image processing sub-session comprises, consists, or consists essentially of a subsequent sub-session, the subsequent sub-session comprising, consisting, or consisting essentially of capturing the region of interest boundary selection, sample boundary selection, sample scale selection and combinations thereof.

4. The method of claim 3, wherein the second data processing sub-session comprises, consists, or consists essentially of capturing user-input data.

5. The method of claim 1, further comprising transferring data from the first image processing sub-session and/or second data processing sub-session to an analysis device or technician.

6. The method of claim 1, further comprising processing a portion of sample that corresponds to the region of interest selection by the analysis device based at least in part on the data from the first image processing sub-session and/or second data processing sub-session.

7. The method of claim 1, further comprising analyzing at least a portion of the sample based at least in part on the data from the first image processing sub-session and/or second data processing sub-session.

8. The method of claim 1, further comprising outputting a report based at least in part on the data from the first image processing sub-session and/or second data processing sub-session.

9. The method of claim 1, wherein the sample image comprises, consists, or consists essentially of one or more frames that represent the sample.

10. The method of claim 9, wherein the region of interest boundary selection comprises, consists, or consists essentially of one or more region of interest boundary selections on one or more sample image.

11. The method of claim 10, wherein the sample boundary selection comprises, consists, or consists essentially of one or more sample boundary overlay on one or more sample image.

12. The method of claim 11, wherein the sample scale selection comprises, consists, or consists essentially of one or more sample scale overlay on one or more sample image.

13. The method of claim 1 wherein providing the region of interest selection session comprises, consists, or consists essentially of: providing a top-level interface that comprises, consists, or consists essentially of a first interface tile, wherein the first interface tile corresponds to the first image processing sub-session, and wherein the first image processing sub-session comprises, consists, or consists essentially of a first image processing sub-session interface level that is at a same level relative to a level of the top-level interface.

14. The method of claim 13, wherein providing the region of interest selection session comprises, consists, or consists essentially of: providing a top-level interface that comprises, consists, or consists essentially of a second interface tile, wherein the second interface tile corresponds to the second data processing sub-session, and wherein the second data processing sub-session comprises, consists, or consists essentially of a second data processing sub-session interface level that is at a same level relative to a level of the top-level interface.

15. The method of claim 3, wherein the region of interest boundary selection, sample boundary selection and/or sample scale selection comprises, consists, or consists essentially of an image overlay.

16. The method of claim 1, wherein the second data processing sub-session is initiated (i) subsequent to or (ii) before the completion of the first image processing sub-session.

17. The method of claim 5, wherein transferring data from the first image processing sub-session and/or second data processing sub-session to an analysis device or technician comprises, consists, or consists essentially of transferring at least one of the first set of data items or the second set of data items.

18. The method of claim 1, wherein the region of interest corresponds to a cutting device.

19. A method of selecting a region of interest in a sample for analysis, the method comprising:
providing by a webserver a region of interest selection session configured to allow a user to navigate a plurality of sub-sessions comprising at least a first image processing sub-session and a second data processing sub-session distinct from the first image processing sub-session;
capturing by a visual display device a sample image during the first image processing sub-session;
capturing by a visual display device a region of interest boundary selection of the sample image during the first image processing sub-session; and
capturing by a visual display device user input during the second data processing sub-session
thereby selecting a region of interest in the sample for analysis.

20. A method of selecting a region of interest in a sample for analysis, the method comprising:
providing by a visual display device a region of interest selection session configured to allow a user to navigate a plurality of sub-sessions comprising at least a first image processing sub-session and a second data processing sub-session distinct from the first image processing sub-session;
capturing by a visual display device a sample image during the first image processing sub-session;
capturing by a visual display device a region of interest boundary selection of the sample image during the first image processing sub-session; and
capturing by a visual display device user input during the second data processing sub-session thereby selecting a region of interest in the sample for analysis.
